(19) United States
(12) Patent Application Publication
(10) Pub. No.: US 2019/0012220 A1
(43) Pub. Date: Jan. 10, 2019

(54) INFORMATION PROCESSING APPARATUS, INFORMATION PROCESSING METHOD, AND INFORMATION PROCESSING PROGRAM

(71) Applicant: FUJITSU LIMITED, Kawasaki-shi (JP)

(72) Inventors: Motoshi Sumioka, Kawasaki (JP); Koki Hatada, Kawasaki (JP); TAKUMI BABA, Kawasaki (JP); Masahide NODA, Kawasaki (JP); Kei TAIRA, Kawasaki (JP); Takashi Ohno, Kobe (JP); Tatsuro Matsumoto, Yokohama (JP); Riichiro Take, Setagaya (JP)

(73) Assignee: FUJITSU LIMITED, Kawasaki-shi (JP)

(21) Appl. No.: 16/128,986

(22) Filed: Sep. 12, 2018

Related U.S. Application Data
(63) Continuation of application No. PCT/JP2016/057949, filed on Mar. 14, 2016.

(51) Int. Cl. G06F 9/54; G06F 17/24; G06F 3/0482; G06F 17/30; H04L 12/58

(52) U.S. Cl. CPC G06F 9/542; G06F 17/241; H04L 51/32; G06F 17/30696; G06F 17/30958; G06F 3/0482

(57) ABSTRACT

An information processing method performed by a computer, the method includes: displaying a first flowchart illustrating a series of steps to achieve an object; when one of tasks in the displayed first flowchart is selected, making a notification to a predetermined requested user of an improvement request that requests an improvement of the selected task; and in accordance with a demand from the predetermined requested user responding to the notification, displaying the first flowchart on a terminal of the predetermined requested user with a part corresponding to the selected task being set editable.

### CROSS-REFERENCE TO RELATED APPLICATION

This application is a continuation application of International Application PCT/JP2016/057949 filed on Mar. 14, 2016 and designated the U.S., the entire contents of which are incorporated herein by reference.

### FIELD

The embodiment discussed herein is related to an information processing apparatus, an information processing method, and an information processing program.

### BACKGROUND

The wisdom and knowledge of multiple persons is superior to that of an individual, and creating a plan with plural persons is significant. On the other hand, if plural persons contribute to a draft of a plan sequentially and repeatedly, it may delay reaching a conclusion of the plan. Recently, some methods for plural persons to continuously reevaluate a plan according to changes in situation have been created. One such method allows plural persons to add and modify tasks for task progress management and personnel assignment management. Another method allows plural persons to share and edit a single flowchart.

One of the conventional techniques assists communication between persons responsible for tasks dependent on each other in concurrent software development. In another technique for social coding, information on results of executing static tests is accumulated to be displayed, by recording evidences that the reviewer visually checks source codes at static tests in actual.

Examples of the related art include Japanese Laid-open Patent Publication No. 2013-218413 and International Publication Pamphlet No. WO 2016/002056.

With such conventional techniques, it is difficult for plural persons to communicate effectively in order to dynamically improve a process to achieve an object. For example, even with the technique allowing plural persons to add and modify tasks, the relationship between tasks and missed or misplaced tasks are difficult to understand. It is therefore difficult to know which tasks and in which order the tasks are to be executed to achieve an object. With the technique allowing plural persons to share and edit a single flowchart, it is difficult for users to communicate concerning the description of an object and improvements in flowcharts.

An aspect of this disclosure provides an information processing apparatus, an information processing method, and an information processing program that assists communication between several persons who are involved in creating a flowchart.

### SUMMARY

According to an aspect of the invention, an information processing method performed by a computer, the method includes: displaying a first flowchart illustrating a series of steps to achieve an object; when one of tasks in the displayed first flowchart is selected, making a notification to a predetermined requested user of an improvement request that requests an improvement of the selected task; and in accordance with a demand from the predetermined requested user responding to the notification, displaying the first flowchart on a terminal of the predetermined requested user with a part corresponding to the selected task being set editable.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an information processing method according to an embodiment;

FIG. 2 is an explanatory diagram illustrating a system configuration example of a social planning system;

FIG. 3 is a block diagram illustrating a hardware configuration example of an information processing apparatus;

FIG. 4 is a block diagram illustrating a hardware configuration example of a terminal apparatus;

FIG. 5 is an explanatory diagram illustrating an example of stored contents of a project DB;

FIG. 6 is an explanatory diagram illustrating an example of stored contents of a flow DB;

FIG. 7 is an explanatory diagram illustrating an example of stored contents of a user DB;

FIG. 8 is an explanatory diagram illustrating an example of stored contents of a request DB;

FIG. 9 is an explanatory diagram (No. 1) illustrating an example of a workflow screen;

FIG. 10 is an explanatory diagram illustrating an example of a request screen;

FIG. 11 is a block diagram illustrating a functional configuration example of the information processing apparatus;

FIG. 12 is an explanatory diagram illustrating an example of an improvement request notification screen;

FIG. 13 is an explanatory diagram (No. 1) illustrating an example of a workflow improvement screen;

FIG. 14 is an explanatory diagram (No. 2) illustrating an example of the workflow improvement screen;

FIG. 15 is an explanatory diagram illustrating an example of an improvement request list flow improvement screen;

FIG. 16 is an explanatory diagram (No. 1) illustrating an example of a workflow selection screen;

FIG. 17 is an explanatory diagram (No. 2) illustrating another example of the workflow selection screen;

FIG. 18 is an explanatory diagram (No. 2) illustrating another example of the workflow screen;

FIG. 19 is an explanatory diagram (No. 3) illustrating still another example of the workflow screen;

FIG. 20 is a flowchart illustrating an example of an improvement request processing procedure of the information processing apparatus;

FIG. 21 is a flowchart illustrating an example of an improvement response processing procedure of the information processing apparatus; and

FIG. 22 is a flowchart illustrating an example of an update processing procedure of the information processing apparatus.

### DESCRIPTION OF EMBODIMENT

Hereinafter, a description is given of an embodiment of an information processing apparatus, an information processing method, and an information processing program according to the disclosure in detail with reference to the drawings.

### Embodiment

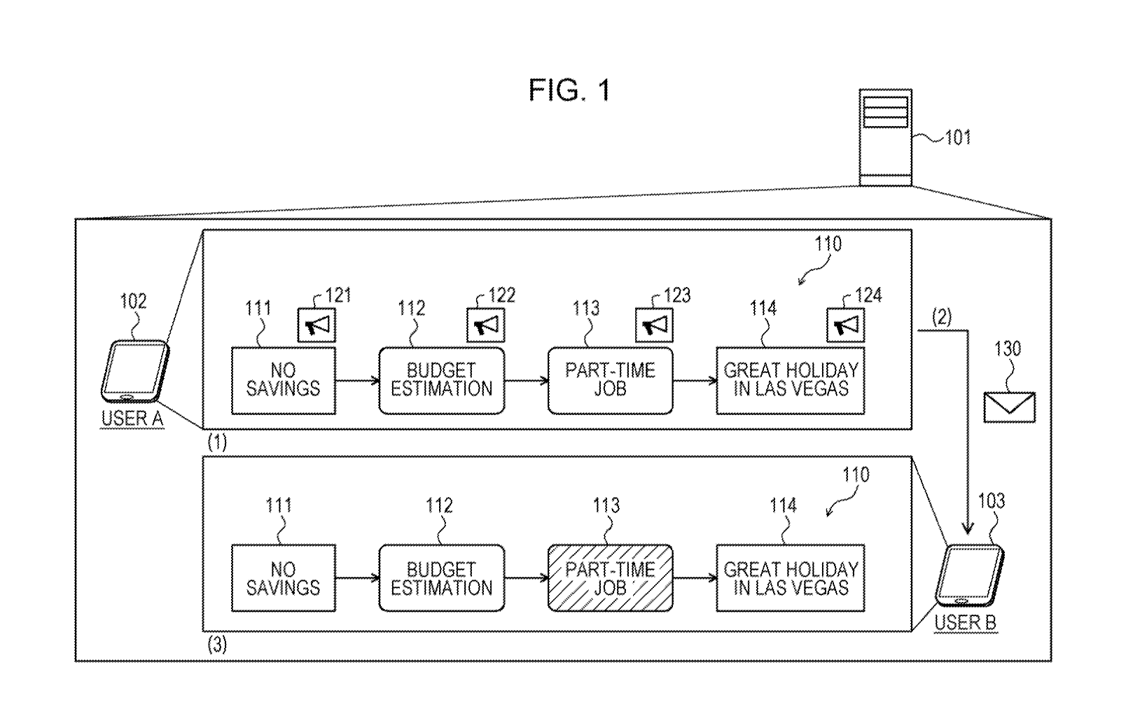

FIG. 1 is an explanatory diagram illustrating an example of the information processing method according to the embodiment. In FIG. 1, an information processing apparatus 101 is a computer that assists communication between several persons who are involved in creating a flowchart. Flowcharts are diagrams illustrating procedures of works and processes.

Flowcharts are useful as a way of displaying a series of steps to achieve a certain object (target) in an understandable way. To create a plan to achieve a certain object with several persons, desirably, the persons easily communicate each other so as to dynamically improve the process to achieve an object.

The embodiment includes an information processing method that assists communication between several users who are involved in creating a flowchart to achieve an object. The description includes a processing example of the information processing apparatus 101. In the following description, works and processes illustrated in flowcharts are sometimes referred to as tasks.

(1) The information processing apparatus 101 displays a flowchart illustrating a series of steps to achieve an object. In the example of FIG. 1, the information processing apparatus 101 displays a flowchart 110 on a terminal apparatus 102. The flowchart 110 is a flowchart illustrating a series of steps to achieve an object of “Great Holiday in Las Vegas”. The flowchart 110 includes tasks 111 to 114. The terminal apparatus 102 is a computer used by a user A who has created the flowchart 110.

(2) When any task in the displayed flowchart is selected, the information processing apparatus 101 notifies a predetermined user of an improvement request that requests an improvement of the selected task. Specifically, in response to selection of any of buttons provided in relation to tasks in the displayed flowchart, the information processing apparatus 101 may accept selection of the task corresponding to the selected button.

In the example of FIG. 1, it is assumed that a button 123 is selected among buttons 121 to 124, which are arranged corresponding to the tasks 111 to 114 in the flowchart 110, respectively. In this case, the information processing apparatus 101 accepts selection of the task 113 corresponding to the selected button 123. The information processing apparatus 101 notifies a predetermined user of an improvement request 130 that requests an improvement of the selected task 113.

The predetermined user is set arbitrarily. For example, the predetermined user may be set in advance or may be set by the requesting user in the process of selecting a task. In the example of FIG. 1, it is assumed that the predetermined user is set to a user B. In this case, the information processing apparatus 101 notifies the user B of the improvement request 130 that requests an improvement of the task 113 in the flowchart 110.

The improvement request 130 includes a comment requesting an improvement of the task 113 in the flowchart 110, for example. The comment includes a request message in a previously determined format (“User A is requesting an improvement of the task 113 in the flowchart 110”, for example), the request details input by the requesting user, and the like.

(3) In accordance with a demand from the requested user responding to the notification, the information processing apparatus 101 displays a flowchart with part corresponding to the selected task set editable. In the example of FIG. 1, the information processing apparatus 101 displays the flowchart 110 on the terminal apparatus 103 with the part corresponding to the task 113 set editable in accordance with a demand from the user B responding to the notification. The terminal apparatus 103 is a computer used by the user B who is notified of the improvement request 130.

The part corresponding to the task 113 may be the task 113 in the flowchart 110 or may include the task 113 and the task 112 preceding the task 113 and/or the task 114 following the task 113, for example. In the example of FIG. 1, only the task 113 in the flowchart 110 is editable and is displayed (highlighted) in a different manner from the other tasks 111, 112, and 114.

According to the information processing apparatus 101, the flowchart illustrating a series of steps to achieve an object is displayed, and when any task in the displayed flowchart is selected, an improvement request that requests an improvement of the task is transmitted to a predetermined user. The improvement request that requests an improvement of the task is thus submitted for the predetermined user with a simple operation that selects a task in the flowchart.

In the example of FIG. 1, with the operation of selecting the button 123, which is provided corresponding to the task 113 in the flowchart 110, the user A notifies the user B of the improvement request 130 that requests an improvement of the task 113. The user B confirms the improvement request 130 and knows not only that there is a request from the user A to improve the task 113 in the flowchart 110 but also the details of the request.

Furthermore, with the information processing apparatus 101, in accordance with a demand from the requested user responding to the notification, the flowchart is displayed with the part corresponding to the selected task set editable and highlighted. It is therefore possible to present the range intended to be improved in the flowchart in an understandable way for the requested user.

In the example of FIG. 1, the user B intuitively knows that the highlighted task 113 in the flowchart 110 is the range intended to be improved and thereby edits the flowchart 110 according to the request of the user A to improve the task 113.

The information processing apparatus 101 facilitates communication that allows several persons to dynamically improve the process to achieve an object, so that several persons create, share, and review the same plan collaboratively.

(System Configuration Example of Social Planning System 200)

Next, a description is given of a system configuration example of a social planning system 200 according to the embodiment.

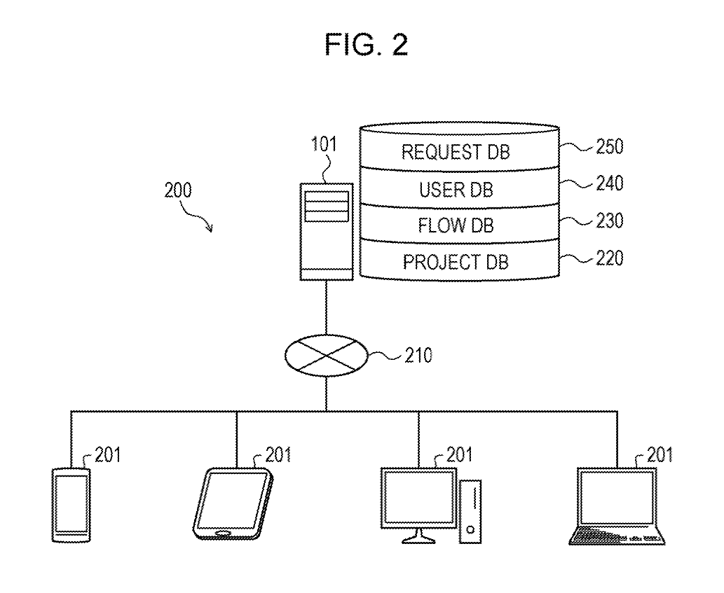

FIG. 2 is an explanatory diagram illustrating the system configuration example of the social planning system 200. In FIG. 2, the social planning system 200 includes the information processing apparatus 101 and plural terminal apparatuses 201 (four apparatuses in the example of FIG. 2). In the social planning system 200, the information processing apparatus 101 and plural terminal apparatuses 201 are connected to each other via a wired or wireless network 210. The network 210 is a local area network (LAN), a wide area network (WAN), or the Internet, for example.

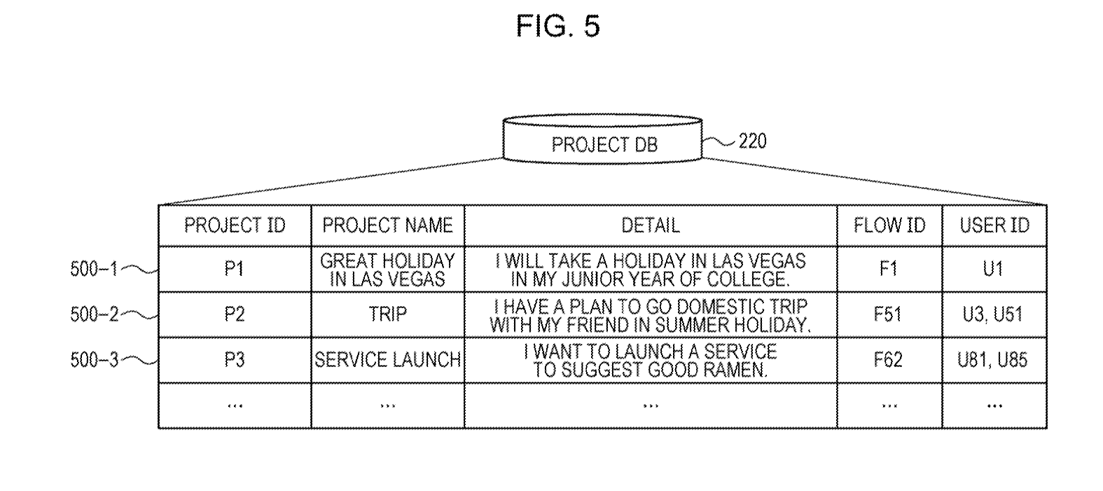

The information processing apparatus 101 includes a project database (DB) 220, a flow DB 230, a user DB 240, and a request DB 250. The information processing apparatus 101 assists communication between plural persons involved in creating a flowchart. The information processing apparatus 101 is a server, for example. The contents stored in the DBs 220, 230, 240, and 250 are described later with reference to FIGS. 5 to 8.

The terminal apparatuses 201 are computers utilized by users of the social planning system 200. The terminal apparatuses 201 are smartphones, tablet personal computers (PCs), desk top PCs, and notebook PCs, for example. The terminal apparatuses 102 and 103 illustrated in FIG. 1 correspond to the terminal apparatuses 201, for example.

(Hardware Configuration Example of Information Processing Apparatus 101)

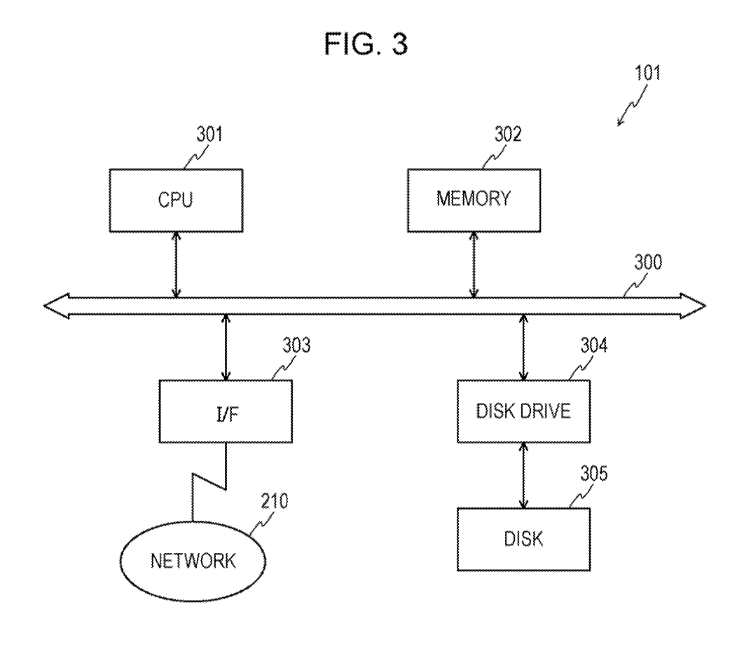

FIG. 3 is a block diagram illustrating a hardware configuration example of the information processing apparatus 101. In FIG. 3, the information processing apparatus 101 includes a central processing unit (CPU) 301, a memory 302, an interface (I/F) 303, a disk drive 304, and a disk 305. These components are connected via a bus 300.

Herein, the CPU 301 manages the entire control of the information processing apparatus 101. The memory 302 includes a read only memory (ROM), a random access memory (RAM), and a flash ROM, for example. Specifically, the ROM or flash ROM stores various programs, and the RAM is used as a work area of the CPU 301, for example. The programs stored in the memory 302 are loaded by the CPU 301 and cause the CPU 301 to execute coded processes.

The I/F 303 is connected to the network 210 through a communication line and is connected to an external computer (the terminal apparatuses 201 illustrated in FIG. 2, for example) via the network 210. The I/F 303 manages the interface between the network 210 and the inside of the information processing apparatus 101. The I/F 303 controls inputs and outputs of data by external computers. The I/F 303 may be a modem, a LAN adaptor, or the like, for example.

The disk drive 304 controls read/write of data for the disk 305 in accordance with control by the CPU 301. The disk 305 stores data written under control by the disk drive 304. The disk 305 is a magnetic disk or an optical disk, for example.

In addition to the aforementioned components, the information processing apparatus 101 may include a solid-state drive (SSD), a keyboard, a mouse, a display, or the like, for example.

(Hardware Configuration Example of Terminal Apparatus 201)

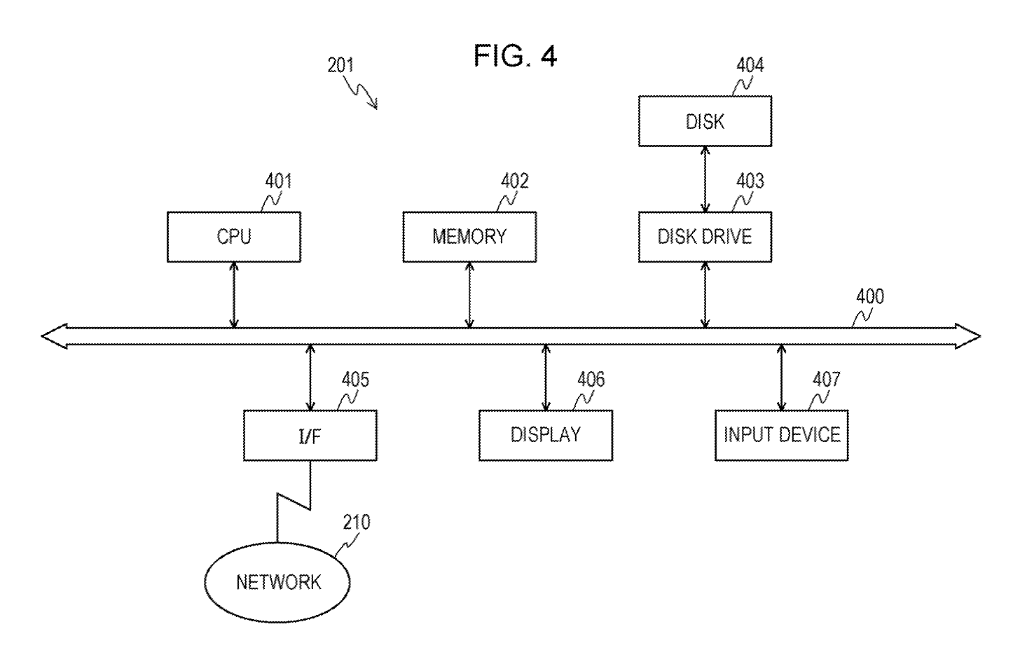

FIG. 4 is a block diagram illustrating a hardware configuration example of the terminal apparatuses 201. As illustrated in FIG. 4, each terminal apparatus 201 includes a CPU 401, a memory 402, a disk drive 403, a disk 404, an I/F 405, a display 406, and an input device 407. These components are connected via a bus 400.

The CPU 401 manages the entire control of the terminal apparatus 201. The memory 402 includes a ROM, a RAM, and a flash ROM, for example. Specifically, the ROM or flash ROM stores various programs, and the RAM is used as a work area of the CPU 401, for example. The programs stored in the memory 402 are loaded by the CPU 401 and causes the CPU 401 to execute coded processes.

The disk drive 403 controls read/write of data for the disk 404 in accordance with control by the CPU 401. The disk 404 stores data written under control by the disk drive 403. The disk 404 is a magnetic disk or an optical disk, for example.

The I/F 405 is connected to the network 210 through a communication line and is connected to an external computer (the information processing apparatuses 101 illustrated in FIG. 2, for example) via the network 210. The I/F 405 manages the interface between the network 210 and the inside of the terminal apparatus 201. The I/F 405 controls inputs and outputs of data by external computers.

The display 406 displays a cursor, icons, a tool box, and data including texts, images, and functional information. The display 406 may be a liquid crystal display, an organic electroluminescence (EL) display, or a cathode ray tube (CRT), for example.

The input device 407 includes keys to input characters, numerals, various instructions, and the like and allows data inputs. The input device 407 may be a keyboard, a mouse, or the like or may be a touch panel-type input pad or a numeric keypad, or the like.

The terminal apparatus 201 may be configured not to include the disk drive 403, disk 404, or the like among the aforementioned components, for example.

(Contents of Project DB 220)

Next, a description is given of the contents of the project DB 220 of the information processing apparatus 101. The project DB 220 is implemented by a storage device including the memory 302 and disk 305 illustrated in FIG. 3, for example.

FIG. 5 is an explanatory diagram illustrating an example of the contents of the project DB 220. In FIG. 5, the project DB 220 includes fields for project ID, project name, details, flow ID, and user ID. These fields are filled with information, and project information (project information 500-1 to 500-3, for example) is thereby stored as a record.

The project ID is an identifier to uniquely identify a project P (plan) to achieve a certain object. The project name is the name of the project P. The details are the details of the project P. The flow ID is an identifier to uniquely identify a flowchart illustrating a series of steps to achieve the object of the project P. The user ID is an identifier to uniquely identify the user involved in the project P.

In the following description, the flowchart illustrating a series of steps to achieve an object is referred to as a workflow F in some cases.

(Contents of Flow DB 230)

Next, a description is given of the contents of the flow DB 230 of the information processing apparatus 101. The flow DB 230 is implemented by a storage device, including the memory 302 and disk 305 illustrated in FIG. 3, for example.

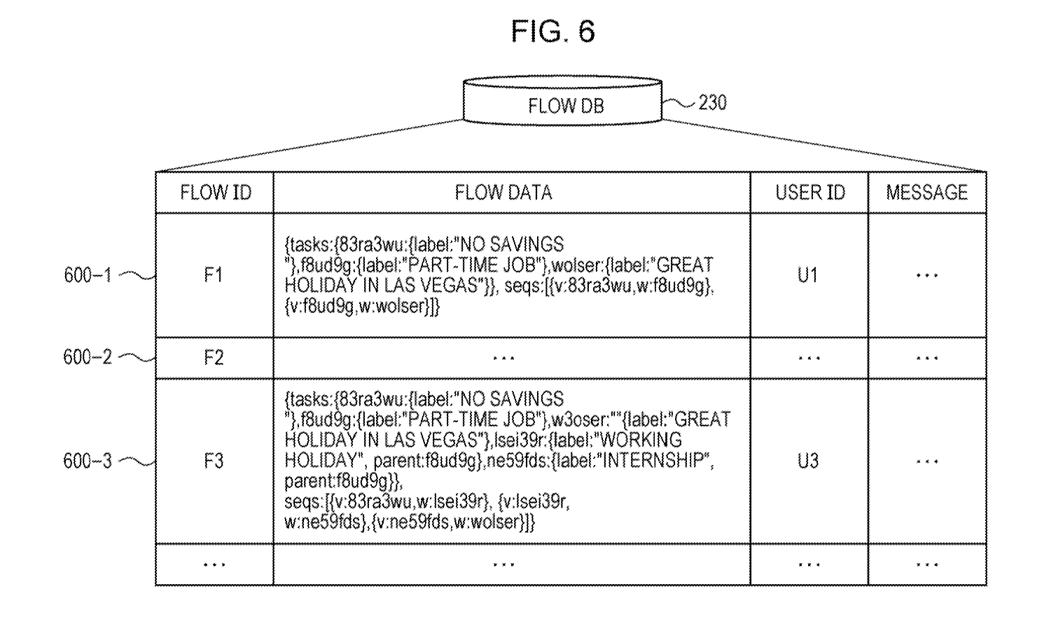

FIG. 6 is an explanatory diagram illustrating an example of the contents of the flow DB 230. In FIG. 6, the flow DB 230 includes fields for flow ID, flow data, user ID, and message. These fields are filled with information, and flow information (flow information 600-1 to 600-3) is thereby stored as a record.

The flow ID is an identifier to uniquely identify the workflow F. The flow data is information of the workflow F. The user ID is an identifier to uniquely identify the user who has edited (or newly created) the workflow F. The message is a message input by the user who has edited the workflow F.

(Contents of User DB 240)

Next, a description is given of the contents of the user DB 240 of the information processing apparatus 101. The user DB 240 is implemented by a storage device, including the memory 302 and disk 305 illustrated in FIG. 3, for example.

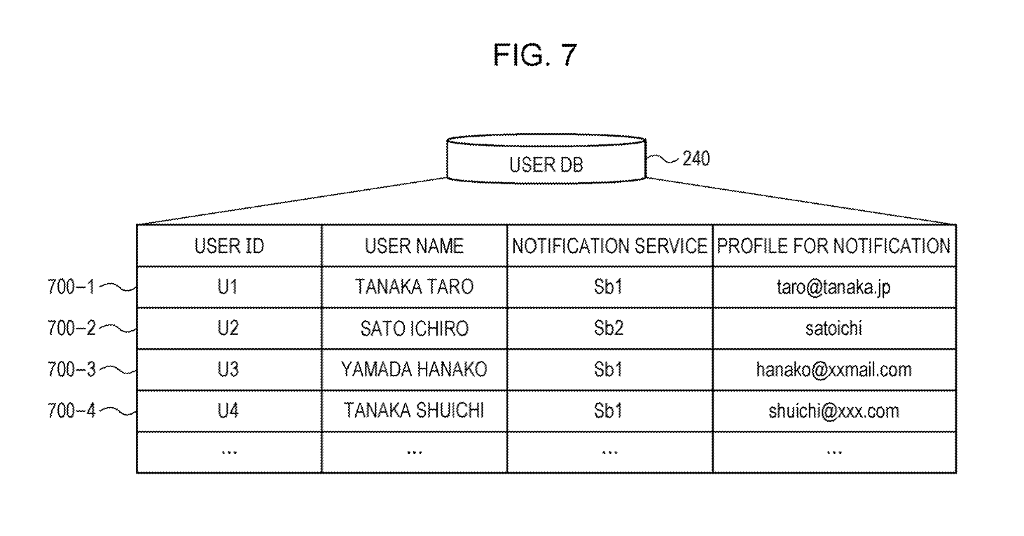

FIG. 7 is an explanatory diagram illustrating an example of contents of the user DB 240. In FIG. 7, the user DB 240 includes fields for user ID, user name, notification service, and notification profile. These fields are filled with information, and flow information (flow information 700-1 to 700-4) is thereby stored as a record.

The user ID is an identifier to uniquely identify each user of the social planning system 200. The user name is the name of the user. The notification service refers to a notification service utilized by the corresponding user. Examples of the notification service include e-mail, social networking services (SNS), and short message services. The notification profile refers to user information utilized by the notification service, including account information.

(Contents of Request DB 250)

Next, a description is given of the contents of the request DB 250 of the information processing apparatus 101. The request DB 250 is implemented by a storage device, including the memory 302 and disk 305 illustrated in FIG. 3, for example.

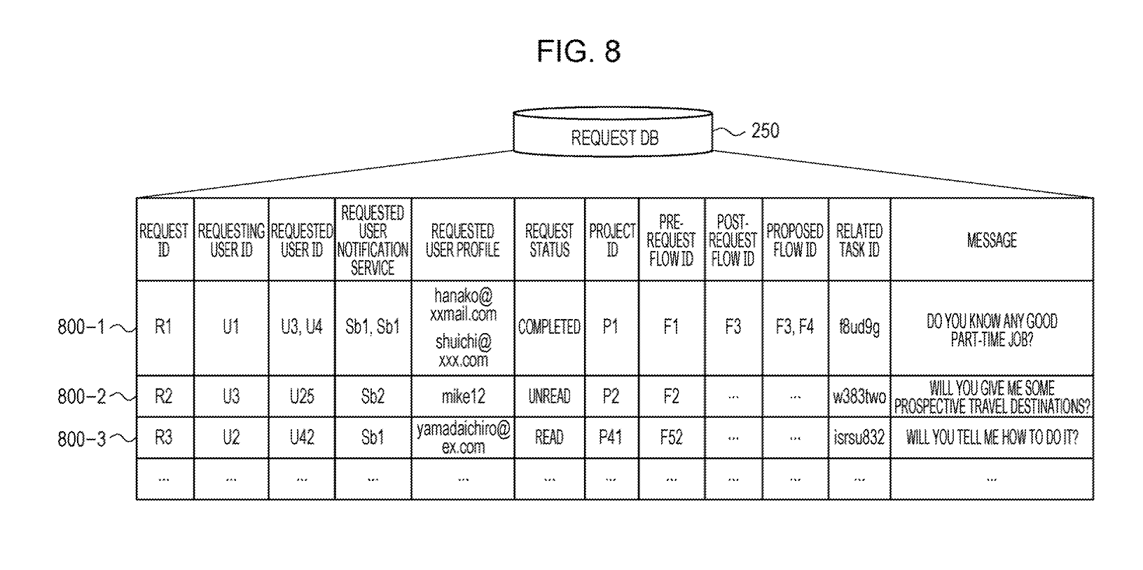

FIG. 8 is an explanatory diagram illustrating an example of the contents of the request DB 250. In FIG. 8, the request DB 250 includes fields for request ID, requestor user ID, requested user ID, requested user service, requested user notification service, requested user notification profile, request status, project ID, pre-request flow ID, post-request flow ID, proposed flow ID, related task ID, and message. These fields are filled with information, and request information (request information 800-1 to 800-3) is thereby stored as a record.

The request ID is an identifier to uniquely identify an improvement request that requests an improvement of a task T in the workflow F. The requesting user ID is an identifier to uniquely identify a user who has submitted the improvement request to improve the task T. The requested user ID is an identifier to uniquely identify a user who has been requested to improve the task T. The requested user notification service is a notification service utilized by the user who has been requested to improve the task T. The requested user profile is a notification profile of the user who has been requested to improve the task T.

The request status refers to a status of the improvement request at the requested user. The request status is set to “unread”, “read”, and “completed”, for example. The “unread” Indicates that the requested user has not yet confirmed the improvement request. The request status is set to “unread” at the beginning. The “read” Indicates that the requested user has confirmed the improvement request but not yet responded to the improvement request. The “completed” indicates that the requested user has completed a response to the improvement request.

The project ID is an identifier to uniquely identify the project P. The pre-request flow ID is an identifier to uniquely identify the workflow F of the project P before the request. The post-request flow ID is an identifier to uniquely identify the workflow F of the project P after the request.

The proposed flow ID is an identifier to uniquely identify a workflow F proposed by the requested user. The related task ID is an identifier to uniquely identify the task T in the workflow F which is requested to be improved. The message is a comment which is input by the requesting user for the requested user.

(Example of Workflow Screen)

Next, a description is given of an example of the workflow screen displayed on the display 406 (see FIG. 4) of the terminal apparatus 201. Herein, the example of the workflow screen is described using the terminal apparatus 201 of a user U1 by way of example.

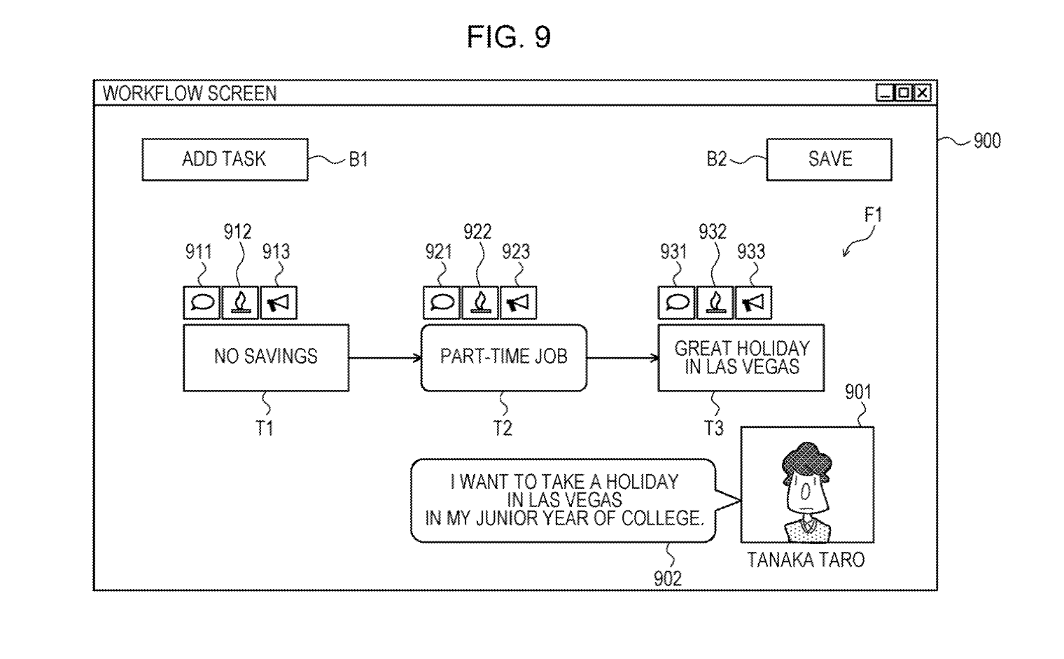

FIG. 9 is an explanatory diagram (No. 1) illustrating an example of the workflow screen. In FIG. 9, a workflow screen 900 is an operation screen displaying a workflow F1 created by the user U1 (user name: Tanaka Taro) as an originator of a project P1 (project name: Great Holiday in Las Vegas). A face image 901 is a face image of the user U1 (user name: Tanaka Taro). The message 902 indicates the contents of the project P1 (project name: Great Holiday in Las Vegas).

The workflow F1 is a flowchart illustrating a series of steps to achieve an object of “Great Holiday in Las Vegas”. The flowchart F1 includes tasks T1 to T3. At the positions corresponding the tasks T1 to T3 in the workflow F1, buttons 911 to 913, 921 to 923, and 931 to 933 corresponding to the tasks T1 to T3 are arranged respectively.

In the workflow screen 900, when a task addition button B1 is selected through user operation using the input device 407 illustrated in FIG. 4, for example, a new task T is added to the workflow F1 for edit of the workflow F1.

In the workflow screen 900, when a store button B2 is selected through user operation, the flow data of the workflow F1 is stored. The flow data of the workflow F1 is stored in the flow DB 230 illustrated in FIG. 6, for example.

In the workflow screen 900, selection of the buttons 911, 921, and 931 corresponding to the tasks T1 to T3 through user operation allows inputs of messages about the tasks T1 to T3, respectively. For example, selection of the button 921 corresponding to the task T2 allows Input of an additional message about the task T2.

The message input for each task T may pop up when the cursor is moved to the task T, for example.

In the workflow screen 900, when the buttons 912, 922, and 932 corresponding to the tasks T1 to T3 are selected through user operation, various stamps (illustrations) are given to illustrate feelings, evaluations, and the like for the tasks T1 to T3, respectively.

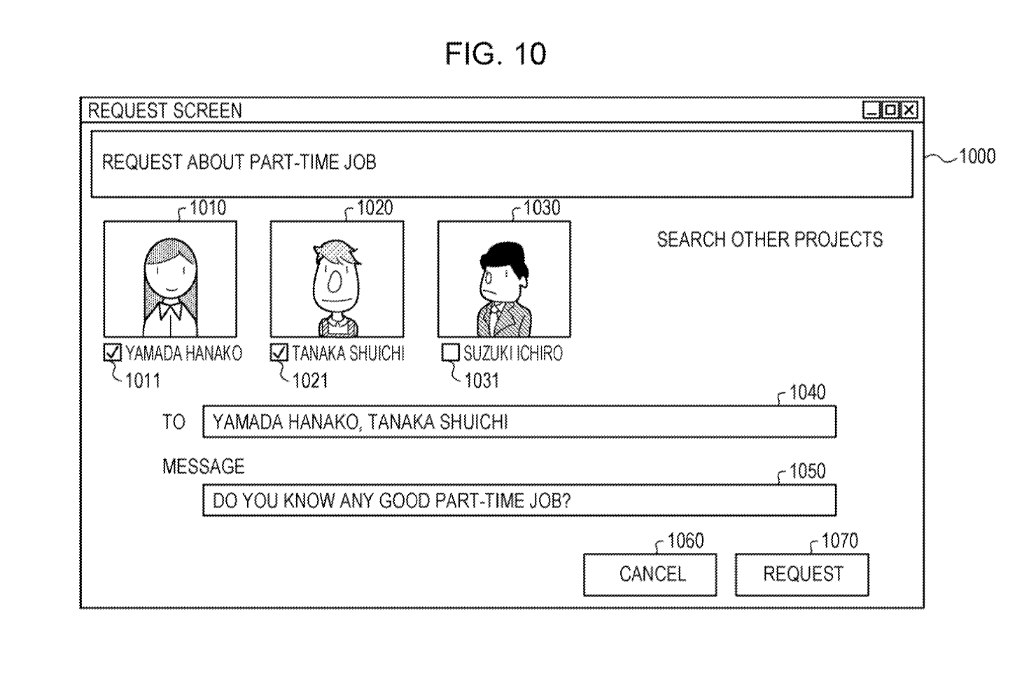

In the workflow screen 900, when the buttons 913, 923, and 933 corresponding to the tasks T1 to T3 are selected through user operation, improvement requests that request improvements of the tasks T1 to T3 are submitted, respectively. For example, when the button 923 corresponding to the task T2 is selected, a request screen 1000 illustrated in FIG. 10 is displayed for an improvement request that requests an improvement of the task T2.

(Example of Request Screen)

Next, a description is given of an example of the request screen displayed on the display 406 (see FIG. 4) of the terminal apparatus 201.

FIG. 10 is an explanatory diagram illustrating an example of the request screen. In FIG. 10, the request screen 1000 is an operation screen which allows selection of users who are to be requested to improve the task T2 in the workflow F1 are selected as requested users. The request screen 1000 is displayed in response to selection of the button 923 in the workflow screen 900 illustrated in FIG. 9, for example.

The request screen 1000 includes face images 1010, 1020, and 1030 of users selectable as the requested users. The users selectable as the requested users may be previously set by the user U1 who has submitted the improvement request or may be users registered in a contact book of the user U1.

In the request screen 1000, when a check box 1011, 1021, or 1031, corresponding to the face images 1010, 1020, and 1030, is selected through user operation, the user corresponding to the selected check box is selected as the requested user. In the example of FIG. 10, the user U3 with a user name of “Yamada Hanako” and the user U4 with a user name of “Tanaka Shuichi” are selected as the requested users.

The box 1040 displays the user names of the users selected as the requested users. In the example of FIG. 10, the user names of “Yamada Hanako” and “Tanaka Shuichi” of the users U3 and U4 selected as the requested users are in the box 1040. The requested users may be selected by directly Inputting user names in the box 1040.

In the request screen 1000, selection of the box 1050 through user operation allows an input of a comment requesting an improvement of the task T2. In the example of FIG. 10, a comment of “Do you know any good part-time job?” that indicates the request details to improve the task T2 is input in the box 1050.

In the request screen 1000, when the button 1060 is selected through user operation, the request to improve the task T2 is cancelled.

In the request screen 1000, when a button 1070 is selected through user operation, the improvement request that requests an improvement of the task T2 is transmitted from the information processing apparatus 101 to the users U3 and U4, who are selected as the requested users. The improvement request includes the comment input in the box 1050.

(Functional Configuration Example of Information Processing Apparatus 101)

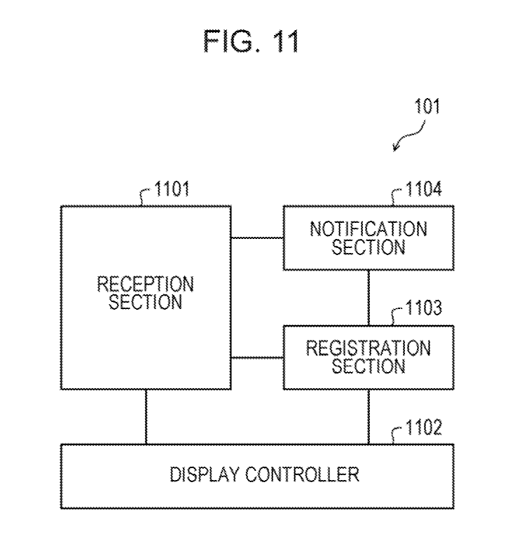

FIG. 11 is a block diagram Illustrating a functional configuration example of the information processing apparatus 101. In FIG. 11, the information processing apparatus 101 includes a reception section 1101, a display controller 1102, a registration section 1103, and a notification section 1104. These components 1101 to 1104 are functions serving as controllers. Specifically, for example, these components 1101 to 1104 implement the functions thereof by causing the CPU 301 to execute the programs stored in the storage device, including the memory 302 and disk 305 illustrated in FIG. 3, or by using the I/F 303. The processing results of the functional sections are stored in the storage device, including the memory 302 and disk 305.

The reception section 1101 accepts a demand to display the workflow F. The demand to display the workflow F includes information to specify the workflow F to be displayed, including the project name, project ID, flow ID, and the like, for example. Specifically, the reception section 1101 accepts a demand to display the workflow F upon receiving the display demand from the terminal apparatus 201.

The display controller 1102 performs a control to display the workflow F. Specifically, upon accepting a demand to display the workflow F, the display controller 1102 extracts from the flow DB 230, the flow information of the workflow F specified based on the information included in the display demand (see FIG. 6, for example).

Next, the display controller 1102 creates screen information of the workflow screen including the workflow F, based on the extracted flow Information. The display controller 1102 transmits the created screen information of the workflow screen to the terminal apparatus 201 of the user who has submitted the display demand (hereinafter, sometimes referred to as a demander). The workflow screen including the workflow F is thereby displayed on the terminal apparatus 201 of the demander.

As an example, it is assumed that the Information processing apparatus 101 accepts a display demand including a project ID of P1 from the terminal apparatus 201 of the user U1. In this case, the display controller 1102 specifies a flow ID of F1 corresponding to the project ID of P1 with reference to the project DB 220 (see FIG. 5, for example).

The display controller 1102 extracts flow information 600-1 corresponding to the specified flow ID (F1) from the flow DB 230. Next, based on the extracted flow information 600-1, the display controller 1102 creates screen information of the workflow screen 900 (see FIG. 9) including the workflow F1. The display controller 1102 transmits the created screen information of the workflow screen 900 to the terminal apparatus 201 of the user U1.

In such a manner, the workflow screen 900 including the workflow F1 is displayed on the terminal apparatus 201 of the user U1. The project ID may be specified based on the user ID of the demander. The display controller 1102 may specify the project ID (P1) corresponding to the user ID (U1) with reference to the project DB 220, for example.

The reception section 1101 accepts selection of a task T in the displayed workflow F. The selection of a task T is performed on the workflow screen 900 illustrated in FIG. 9, for example. When the task T2 is selected in the workflow screen 900, for example, the reception section 1101 receives the results of selection, indicating that the task T2 is selected, from the terminal apparatus 201 and thereby accepts selection of the task T2 of the workflow F1.

The display controller 1102 may perform a control to display an input field in which a comment that requests an improvement of the selected task T in response to selection of the task T on the displayed workflow F. The display controller 1102 may perform a control to display a screen which allows selection of a user who is to be requested to improve the selected task T, in response to selection of the task T on the displayed workflow F.

It is assumed that the task T2 is selected in the workflow screen 900, for example. In this case, the display controller 1102 displays on the terminal apparatus 201 of the user U1, a request screen (the request screen 1000 illustrated in FIG. 10, for example) allowing selection of a user who is to be requested to improve the selected task T2, for example. The request screen includes an input field which allows input of a comment that requests an improvement of the selected task T2 (a box 1050 illustrated in FIG. 10, for example).

The reception section 1101 accepts an improvement request that requests an improvement of the selected task T. The request to improve a task T is performed in the request screen 1000 illustrated in FIG. 10, for example. It is assumed that the button 1070 is selected on the request screen 1000 after the users U3 and U4 are selected as the requested users, for example.

In this case, the reception section 1101 receives an improvement request that requests the users U3 and U4 to improve the task T2, from the terminal apparatus 201 of the user U1 and thereby accepts the improvement request. The request to improve the task T2 includes the comment input in the box 1050 of the request screen 1000, for example.

In response to the reception section 1101 accepting the improvement request to improve a task T, the registration section 1103 registers new request information in the request DB 250 (see FIG. 8, for example). Herein, it is assumed that the reception section 1101 accepts an improvement request that requests the users U3 and U4 to improve the task T2, from the terminal apparatus 201 of the user U1.

First, the request ID of the request information is numbered. Herein, the request ID is assigned to R1. The requesting user ID of the request Information is set to U1, which is the user ID of the user who has submitted the improvement request. The requested user ID is set to user IDs of U3 and U4, which are users to be requested to improve the task T. The requested user notification service is set to notification services Sb1 and Sb1 of the users U3 and U4 as the requested users.

The requested user profile is set to the notification profiles of the users U3 and U4, which are users to be requested to improve the task T, of hanako@xxmail.com and shuichi@xxx.com. The notification services and profiles of the users U3 an U4 are specified based on the user DB 240, for example.

The request status is set to “unread”. The project ID is set to a project ID “P1”. The pre-request flow ID is set to the flow ID “F1” of the workflow F1. The related task ID is set to an identifier to uniquely identify the task T2 intended to be improved.

The message is set to a comment included in the improvement request (a request message indicating the request details to improve the task T2, for example). At this time, the post-request flow ID and proposed flow ID are set to “- (null)”. New request information 800-1 (see FIG. 8) is thereby registered in the request DB 250.

The notification section 1104 notifies the predetermined requested users of an improvement request that requests an improvement of the selected task T. The predetermined requested users are the users U3 and U4, who are selected as the requested users on the request screen 1000 (see FIG. 10), for example. The predetermined requested users may be set in advance.

Specifically, the notification section 1104 creates information of the Improvement request that requests an improvement in the task T2 in the workflow F1 with reference to the request information 800-1 of the request DB 250, for example. The information of the improvement request includes the request ID “R1” of the request information 800-1 and a message of “Do you know any good part-time job?”, for example.

Next, the notification section 1104 specifies the requested user notification services and profiles of the requested users U3 and U4, with reference to the request Information 800-1. Based on the notification profiles of the requested users U3 and U4, the notification section 1104 notifies the users U3 and U4 of the created improvement request, based on the notification profiles of the requested user U3 and U4, using the requested user notification services of the requested users U3 and U4.

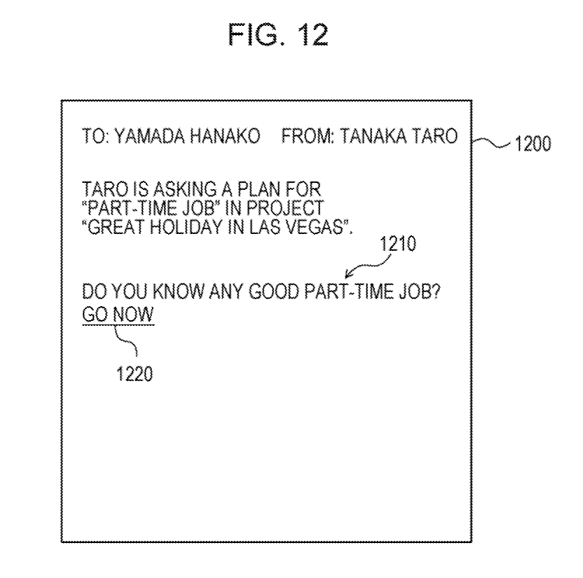

Then, in the terminal apparatuses 201 of the requested users U3 and U4, for example, an improvement request notification screen is displayed based on the information of the improvement request received from the requesting user U1. An example of the improvement request notification screen is described later using FIG. 12.

The reception section 1101 accepts a demand to display an edit screen for the workflow F. The demand to display an edit screen for the workflow F is a demand to display an operation screen for editing the workflow F. The demand to display an edit screen for the workflow F is submitted on an improvement request notification screen 1200 illustrated in FIG. 12 later described, for example.

Specifically, the reception section 1101 receives a demand to display the edit screen for the workflow F from the terminal apparatus 201 of a requested user and thereby accepts the demand to display the edit screen, for example. The demand to display the edit screen for the workflow F includes a request ID to uniquely identify the improvement request that requests an improvement of a task T in the workflow F, for example.

When the reception section 1101 accepts the demand to display the edit screen for the workflow F, the registration section 1103 changes the request status of the request information in the request DB 250 corresponding to the request ID included in the display demand to “read”.

The display controller 1102 performs a control to display the workflow F so that the part corresponding to the selected task T in the workflow F is editable and highlighted. Herein, the part corresponding to the selected task T in the workflow F may be the selected task T in the workflow F itself or may include the selected task T and the tasks T preceding and forwarding the selected task T, for example.

Highlighting the part corresponding to the selected task T in the workflow F includes displaying the part corresponding to the selected task T in a different fashion from the other part. The display controller 1102 may display the part corresponding to the selected task T in the workflow F with a different font, character color, background color, or symbols from the other part.

Specifically, in accordance with the demand to display the edit screen for the workflow F from the requested user responding to the notification, the display controller 1102 extracts from the request DB 250, the request information corresponding to the request ID included in the demand to display the edit screen. The display controller 1102 then extracts from the flow DB 230, the flow information corresponding to the pre-request flow ID of the extracted request information.

Next, the display controller 1102 creates screen information of the workflow improvement screen based on the extracted flow information. The workflow improvement screen is an operation screen that displays the workflow F in which the part corresponding to the selected task T in the workflow F is editable and highlighted. The selected task T is specified by the related task ID of the request information, for example.

The display controller 1102 transmits the created screen information of the workflow improvement screen to the terminal apparatus 201 of the demander. The workflow improvement screen is thereby displayed on the terminal apparatus 201 of the demander (the user who has submitted the demand to display the edit screen for the workflow F).

It is assumed that the display controller 1102 accepts a demand to display the edit screen including the request ID of R1 from the terminal apparatus 201 of the user U3, for example. In this case, the display controller 1102 extracts from the request DB 250, the request information 800-1 corresponding to the request ID of R1 included in the demand to display the edit screen.

The display controller 1102 extracts from the flow DB 230, flow information corresponding to the pre-request flow ID of F1 of the extracted request information 800-1. Next, the display controller 1102 creates screen information of the workflow improvement screen based on the extracted flow information 600-1. The display controller 1102 transmits the created screen information of the workflow improvement screen to the terminal apparatus 201 of the user U3.

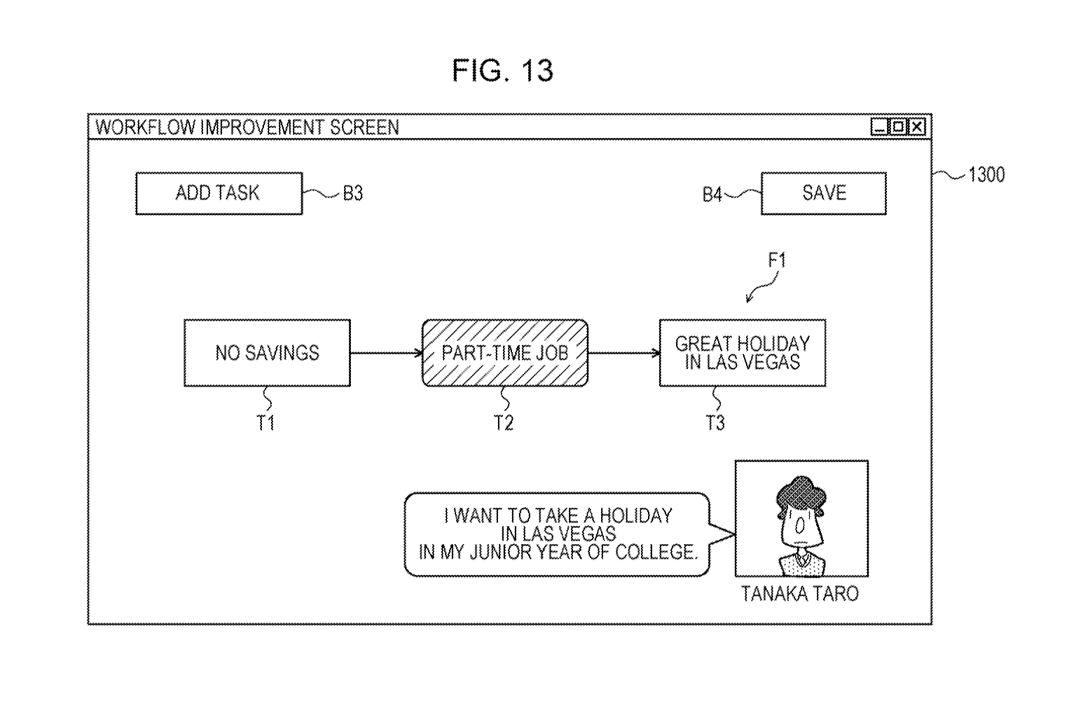

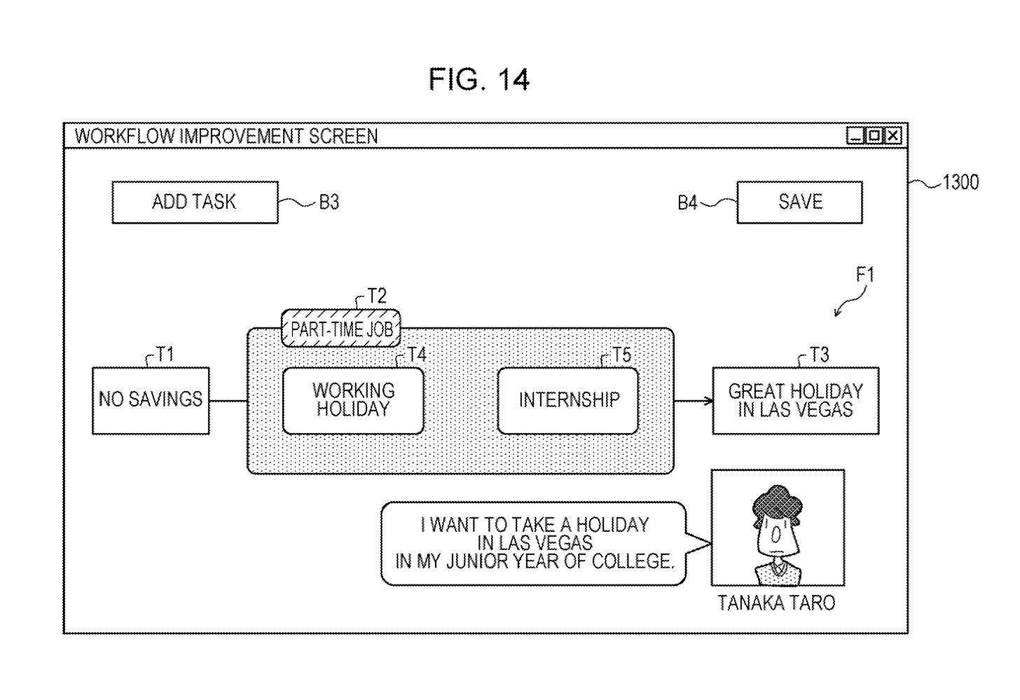

The workflow improvement screen in which the part corresponding to the selected task T2 in the workflow F1 is editable and highlighted is thereby displayed in the terminal apparatus 201 of the user U3. An example of the workflow improvement screen is described later using FIGS. 13 and 14.

The reception section 1101 accepts an instruction to store the edited workflow F. The instruction to store the edited workflow F is performed after the workflow F is edited on the workflow improvement screen Illustrated in FIGS. 13 and 14 described later, for example.

Specifically, the reception section 1101 receives an instruction to store the edited workflow F from the terminal apparatus 201 of the user requested to improve the workflow F (that is, the user who has submitted the demand to display the edit screen for the workflow F) and thereby accepts the instruction to store the edited workflow F, for example. The instruction to store the edited workflow F includes: the request ID included in the Information of the improvement request transmitted to the requested user; and the flow data of the edited workflow F.

In response to the reception section 1101 accepting the instruction to store the edited workflow F, the registration section 1103 registers the flow information of the edited workflow F in the flow DB 230. Specifically, for example, the registration section 1103 first numbers the flow ID of the edited workflow F and sets the number of the flow ID as the proposed flow ID of the request information in the request DB 250 corresponding to the request ID included in the instruction to store the edited workflow F.

The registration section 1103 registers the flow information of the edited workflow F in the flow DB 230 based on the flow data included in the instruction to store the edited workflow F. The flow information of the workflow F which has been edited by the requested user is thereby newly registered in the flow DB 230.

The reception section 1101 accepts an instruction to respond to the improvement request. The instruction to respond to the improvement request is performed on a not-illustrated message input screen, for example. The message input screen (not illustrated) is an operation screen which is displayed in response to the instruction to store the edited workflow F, on the terminal apparatus 201 of the user requested to improve the workflow F.

In the message input screen (not illustrated), a message from the requested user to the requesting user is input. When input of the message is completed on the message input screen (not illustrated), the response instruction including the input message is transmitted from the terminal apparatus 201 to the information processing apparatus 101. In this case, the reception section 1101 receives the response instruction including the message from the terminal apparatus 201 to the requesting user and thereby accepts the response instruction.

In response to the reception section 1101 accepting the instruction to respond to the improvement request, the notification section 1104 notifies the requesting user of the improvement response indicating that the part corresponding to the selected task T in the workflow F is edited. Specifically, for example, with reference to the user DB 240, the notification section 1104 specifies the notification service and profile corresponding to the user ID of the requesting user, who has submitted the improvement request.

The user ID of the user (requestor) who has submitted the Improvement request is specified based on the request information corresponding to the request ID included in the instruction to store the edited workflow F, for example. The notification section 1104 notifies the requesting user of the improvement response indicating that the part corresponding to the selected task T in the workflow F is edited, using the specified notification service of the requesting user based on the specified notification profile of the requesting user.

For example, the notification screen (not illustrated) based on the Improvement response transmitted from the information processing apparatus 101 is then displayed on the terminal apparatus 201 of the requesting user. The improvement response includes the request ID to uniquely identify the improvement request, for example. The requesting user, who has submitted the improvement request, thereby knows that the part corresponding to the selected task T in the workflow F is edited.

The reception section 1101 accepts a demand to display improvements. The demand to display improvements is a demand to display the edited workflow F in which the part corresponding to the selected task T in the workflow F is edited. The demand to display improvements is submitted on the notification screen (not illustrated) based on the improvement response transmitted from the information processing apparatus 101, for example.

Specifically, the reception section 1101 receives a demand to display improvements from the terminal apparatus 201 of the requesting user, who has submitted the improvement request, and thereby accepts the demand to display improvements, for example. The demand to display improvements includes the request ID to uniquely identify the improvement request, for example.

The display controller 1102 performs a control to display the edited workflow F. Specifically, the display controller 1102 may display the workflow F edited by the user requested to improve the workflow F, on the terminal apparatus 201 of the requesting user, who has submitted the improvement request, in relation to the requested user.

More specifically, for example, in response to the reception section 1101 accepting the demand to display improvements, the display controller 1102 extracts from the request DB 250, the request information corresponding to the request ID included in the demand to display improvements. Next, the display controller 1102 extracts from the flow DB 230, the flow information corresponding to the pre-request flow ID and proposed flow ID in the extracted request information.

When the proposed flow ID of the request information includes plural flow IDs, the display controller 1102 extracts the flow information corresponding to each flow ID set in the proposed flow ID. Next, based on the extracted flow information corresponding to the pre-request flow ID and proposed flow ID, the display controller 1102 creates image information of the workflow selection screen.

The workflow selection screen is an operation screen including unedited workflows F and edited workflows F. When the proposed flow ID includes plural flow IDs, that is, when there are plural edited workflows F, the display controller 1102 may juxtapose the plural edited workflows F against each other.

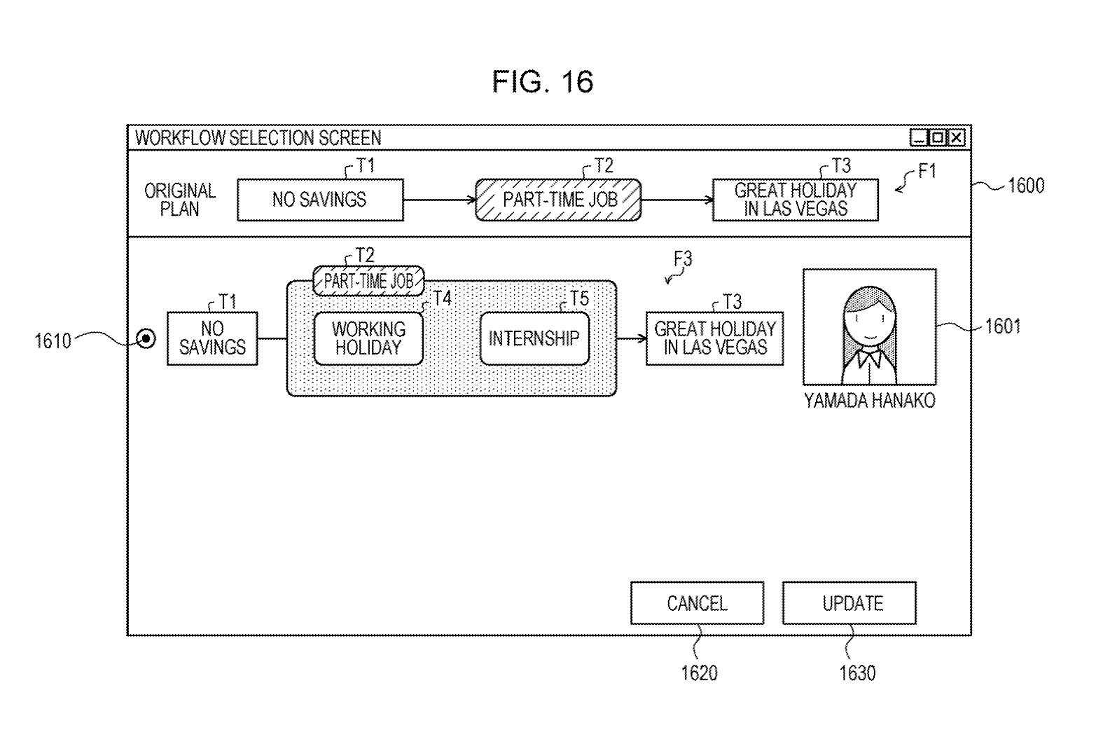

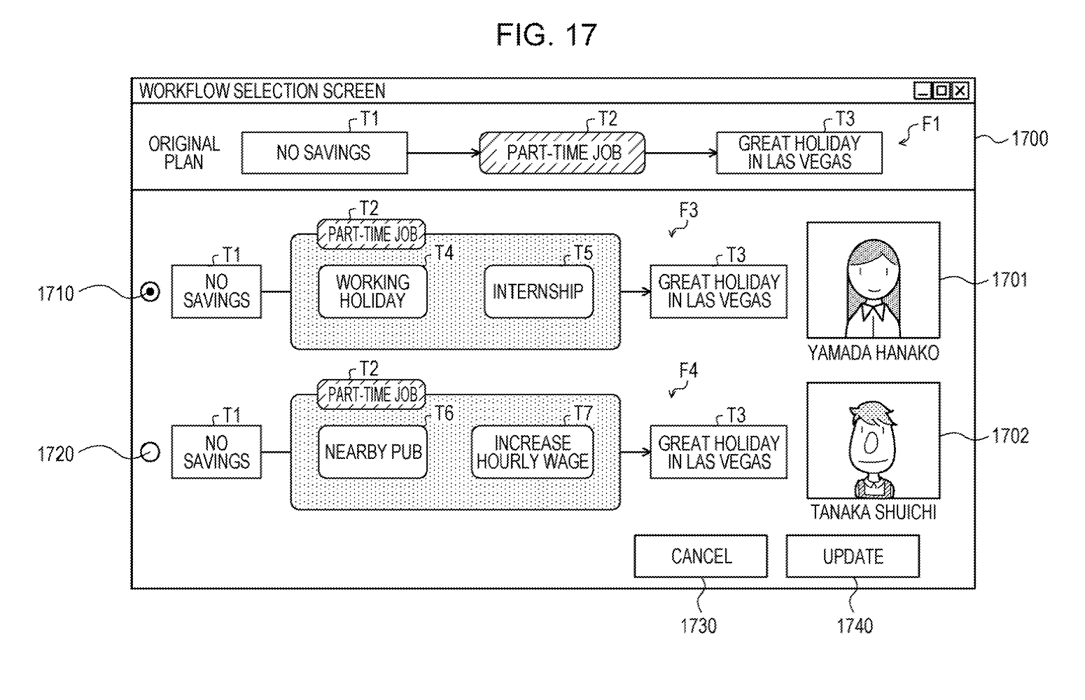

The display controller 1102 transmits the created image information of the workflow selection screen to the terminal apparatus 201 of the requesting user, who has submitted the improvement request. The workflow selection screen including the edited workflow F is thereby displayed on the terminal apparatus 201 of the requesting user, who has submitted the improvement request. An example of the workflow selection screen is described later using FIGS. 16 and 17.

In the example described above, the request information corresponding to the request ID included in the demand to display improvements is extracted from the request DB 250 in response to the demand to display improvements. However, the embodiment is not limited to this. The display controller 1102 may display an improvement request list screen on the terminal apparatus 201 of the requesting user, who has submitted the improvement request, in response to the demand to display improvements.

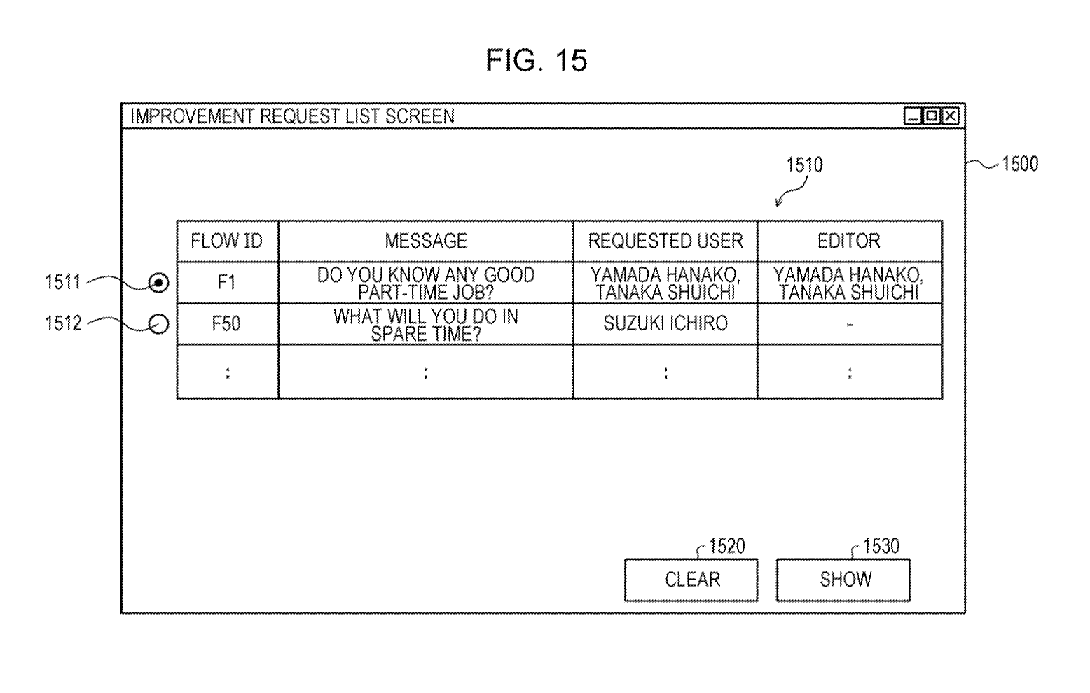

The Improvement request list screen is an operation screen that displays a list of improvement requests from a requesting user. When any improvement request is selected on the improvement list screen, the display controller 1102 may extract the request information corresponding to the selected improvement request from the request DB 250. The display controller 1102 may create screen information of the workflow selection screen based on the extracted request information. An example of the improvement request list screen is described later using FIG. 15.

The reception section 1101 accepts selection of an edited workflow F. The selection of an edited workflow F is performed on the workflow selection screen illustrated in FIGS. 16 and 17 described later, for example. Specifically, the reception section 1101 accepts selection of an edited workflow F by receiving the result of selecting the edited workflow F from the terminal apparatus 201 of the requesting user, who has submitted the improvement request. The result of selecting an edited workflow F includes the flow ID to uniquely identifying the edited workflow F, for example.

In response to selection of the edited workflow F, the registration section 1103 updates the workflow F to the selected edited workflow F. Specifically, the registration section 1103 sets the post-request flow ID in the request information corresponding to the request ID of the improvement request to the flow ID of the selected edited workflow F and changes the request status in the request information to “completed”.

The flow ID of the selected edited workflow F is included in the result of selecting the edited workflow F, for example.

The registration section 1103 specifies the project information corresponding to the flow ID of an unedited workflow F, in the project DB 220. The registration section 1103 updates the flow ID of the specified project information to the flow ID of the selected edited workflow F. The workflow F is thereby updated to the selected edited workflow F.

The registration section 1103 may set the flow ID of the edited but not selected workflow F in the specified project information as another proposed flow ID.

(Example of Improvement Request Notification Screen)

Next, using FIG. 12, a description is given of an example of the improvement request notification screen displayed on the display 406 of the terminal apparatus 201 of the user requested to improve the workflow F. In the example described herein, it is assumed that the user U1 (user name: Tanaka Taro) has requested the user U3 (user name: Yamada Hanako) to improve the workflow F.

FIG. 12 is an explanatory diagram illustrating an example of the improvement request notification screen. In FIG. 12, the improvement request notification screen 1200 is an operation screen which displays an improvement request that requests an improvement of the task T2 in the workflow F1. The improvement request notification screen 1200 includes a comment 1210 and a link 1220.

The comment 1210 is a request message that requests an improvement of the task T2 in the workflow F1. The comment 1210 corresponds to the comment input in the box 1050 of the request screen 1000 illustrated in FIG. 10. The link 1220 is a hyperlink to display the workflow improvement screen.

With the improvement request notification screen 1200, the user U1 (user name: Tanaka Taro) is able to request the user U3 (user name: Yamada Hanako) to improve the task T2 of part-time job in the workflow F1. The user U3, who has been requested to improve the task T2, finds that the improvement request is asking “Do you know any good part-time job?”.

In the improvement request notification screen 1200, when the link 1220 is selected through operation of the requested user U3, a workflow improvement screen 1300 allowing edit of the workflow F1 is displayed as illustrated in FIG. 13.

(Example of Workflow Improvement Screen)

Next, using FIGS. 13 and 14, a description is given of an example of the workflow improvement screen displayed on the display 406 of the terminal apparatus 201 of the user requested to improve a workflow F. In the example described herein, it is assumed that the user U1 (user name: Tanaka Taro) has requested the user U3 (user name: Yamada Hanako) to improve a workflow F.

FIG. 13 is an explanatory diagram (No. 1) illustrating an example of the workflow improvement screen. In FIG. 13, the workflow improvement screen 1300 is an operation screen allowing edit of the workflow F1. In the workflow improvement screen 1300, the selected task T2 in the workflow F1 is editable and is highlighted.

With the workflow improvement screen 1300, the part corresponding to the task T2 is editable and highlighted, and the user U3 (user name: Yamada Hanako) easily knows the part requested to be improved in the workflow F1.

In the workflow improvement screen 1300, when a task addition button B3 is selected through operation of the user U3 (user name: Yamada Hanako), for example, a new task T is added to the task T2 in the workflow F1 for edit of the workflow F1.

FIG. 14 is an explanatory diagram (No. 2) illustrating another example of the workflow improvement screen. In FIG. 14, the workflow Improvement screen 1300 displays the edited workflow F1. Specifically, new tasks T4 and T5 are added to the task T2 in the workflow F1.

In such a manner, the workflow improvement screen 1300 allows edit of the part corresponding to the task T2 in the workflow F1 selected by the user U1 (user name: Tanaka Taro), who has submitted the improvement request. The part other than the part corresponding to the task T2 on the workflow F1 is uneditable.

In the workflow improvement screen 1300, for example, when a save button B4 is selected through the operation of the user U3 (user name: Yamada Hanako), for example, an instruction to store the edited workflow F1 is submitted. When the save button B4 is selected, for example, the instruction to store the edited workflow F1 is transmitted to the information processing apparatus 101, and the flow information 600-3 (see FIG. 6) of the edited workflow F1 is newly registered in the flow DB 230.

When the user U3 is unregistered in the service (social planning service), the information processing apparatus 101 may invite the user U3 to service registration in response to selection of the save button 14 in the workflow improvement screen 1300 or any other action, for example.

When tasks T of the workflow F constitute a class structure, the information processing apparatus 101 displays a task T requested to be improved and tasks T therearound (the preceding and forwarding tasks T, for example) in detail while displaying the other tasks T in a contracted manner (displaying only the topmost task T, for example). This facilitates understanding of the entire workflow F. The class structure of tasks T refers to a structure in which one of the tasks T includes another task T inside, for example.

When the progress of the tasks T is able to be specified in conjunction with a progress management service or the like, the information processing apparatus 101 may perform a control to disable alteration of finished tasks T in the workflow F, for example. Alternatively, when any finished task T is altered, the information processing apparatus 101 may change the progress state of the task T. The information processing apparatus 101 may display the executant and progress of each task T in relation to the task in the workflow F.

The information processing apparatus 101 may color tasks T in the workflow F with different colors based on resources (files, for example). This allows human to easily confirm the dependency between the tasks T. The information of the resource used in each task T (the file name, for example) may be stored in the flow DB 230.

(Example of Improvement Request List Screen)

Next, using FIG. 15, a description is given of an example of the improvement request list screen displayed on the display 406 of the terminal apparatus 201 of the user who has submitted an improvement request. In the example described herein, it is assumed that the user U1 (user name: Tanaka Taro) has submitted an improvement request.

FIG. 15 is an explanatory diagram illustrating an example of the improvement request list screen. In FIG. 15, an improvement request list screen 1500 is an operation screen that displays an improvement request list 1510. The improvement request list 1510 is a list of improvement requests submitted by the user U1 (user name: Tanaka Taro). The improvement request list 1510 is created based on the request information in the request DB 250 with the requesting user ID set to the user ID (U1) of the user who has submitted the improvement request, for example.

The improvement request list 1510 includes the flow IDs, messages, requested users, and editors in relation to each other. The flow IDs are flow IDs of workflows F including a task T requested to be improved. The messages are comments requesting improvements in the tasks T. The requested users are users who have been requested to improve the tasks T. The editors are users who have edited the workflows F in response to improvement requests.

In the improvement request list screen 1500, when a checkbox (a checkbox 1511 or 1512, for example) is selected through operation of the user U1 (user name: Tanaka Taro), for example, the improvement request corresponding to the selected checkbox is selected. In the improvement request list screen 1500, when a clear button 1520 is selected, the selected checkbox is deselected.

In the improvement request list screen 1500, when a display button 1530 is selected, the workflow selection screen corresponding to the selected improvement request is displayed. For example, when the display button 1530 is selected after the checkbox 1511 is selected, a workflow selection screen 1600 is displayed as illustrated in FIG. 16.

(Example of Workflow Selection Screen)

Next, using FIGS. 16 and 17, a description is given of an example of a workflow selection screen displayed on the display 406 of the terminal apparatus 201 of the user who has submitted an improvement request. In the example described herein, it is assumed that the user U1 (user name: Tanaka Taro) has submitted an improvement request.

FIG. 16 is an explanatory diagram illustrating an example (No. 1) of the workflow selection screen. In FIG. 16, the workflow selection screen 1600 is an operation screen including the workflow F1 and workflow F3. The workflow F1 is a workflow F which includes the task T2 requested to be improved but is not edited. The workflow F3 is obtained by editing the workflow F1 and includes the task T2 improved. The workflow F3 is displayed in relation to a face image 1601 of the user U3 (user name: Yamada Hanako), who has been requested to improve the workflow F1.

With the workflow selection screen 1600, the use U1 (user name: Tanaka Taro) is able to confirm the workflow F3 edited by the user U3 (user name: Yamada Hanako). With reference to the tasks T4 and T5 in the workflow F3, for example, the user U1 knows ideas of working holiday and internship as a part-time job to raise money for a great holiday in Las Vegas.

In the workflow selection screen 1600, when a checkbox 1610 is selected through operation of the user U1 (user name: Tanaka Taro), for example, the workflow F3 corresponding to the checkbox 1610 is selected. In the workflow selection screen 1600, when a cancel button 1620 is selected, the selected checkbox is deselected.

In the workflow selection screen 1600, when an update button 1630 is selected after the checkbox 1610 is selected, the selection result indicating that the workflow F3 is selected is transmitted to the information processing apparatus 101. The flow ID corresponding to the project P1 in the project DB 220 with a project name of “Great Holiday in Las Vegas” is then updated from the flow ID (F1) of the workflow F1 to the flow ID (F3) of the workflow F3.

The workflow selection screen 1600 may display a message from the requested user to the requesting user, which is input in the message input screen (not illustrated) displayed on the terminal apparatus 201 of the requested user.

FIG. 17 is an explanatory diagram (No. 2) illustrating an example of the workflow selection screen. In FIG. 17, a workflow selection screen 1700 is an operation screen including the workflow F1, the workflow F3, and a workflow F4. The workflow F1 is a workflow F which includes the task T2 requested to be improved but is unedited.

The workflow F3 is the edited workflow F1 with the task T2 improved. The workflow F3 is displayed in relation to a face image 1701 of the requested user U3 (user name: Yamada Hanako), who has been requested to improve the task T2. The workflow F4 is the edited workflow F1 with the task T2 improved. The workflow F4 is displayed in relation to a face image 1702 of the user U4 (user name: Tanaka Shuichi), who has been requested to improve the task T2.

The workflow selection screen 1700 allows the user U1 (user name: Tanaka Taro) to confirm the workflow F3 edited by the user U3 (user name: Yamada Hanako). For example, the user U1 (user name: Tanaka Taro) sees the tasks T4 and T5 in the workflow F3 and is able to know “working holiday” and “internship” as a part-time job to raise money for a great holiday in Las Vegas.

The workflow selection screen 1700 allows the user U1 (user name: Tanaka Taro) to confirm the workflow F4 edited by the user U4 (user name: Tanaka Shuichi). For example, the user U1 (user name: Tanaka Taro) sees the tasks T6 and T7 in the workflow F4 and is able to know “nearby pub” as a part-time job to raise money for a great holiday in Las Vegas and an idea of trying to increase hourly wage at the pub.

With the workflow selection screen 1700, the workflows F3 and F4 are juxtaposed against each other. This allows the user U1 to easily compare the workflows F3 and F4 and easily determine which workflow F3 or F4 is to be employed.

In the workflow selection screen 1700, when any one of the checkboxes 1710 and 1720 is selected through operation of the user U1 (user name: Tanaka Taro), the edited workflow F corresponding to the selected checkbox is selected. In the workflow selection screen 1700, when a cancel button 1730 is selected, the selected checkbox is deselected.

In the workflow selection screen 1700, when an update button 1740 is selected, the selection result indicating that the edited workflow F corresponding to the selected checkbox is selected is transmitted to the information processing apparatus 101. When the update button 1740 is selected after the checkbox 1710 is selected, for example, the selection result indicating that the workflow F3 is selected is transmitted to the information processing apparatus 101.

(Example of Post-Update Workflow Screen)

Next, a description is given of an example of a post-update workflow screen in which a workflow F is updated to an edited workflow F. In the example described herein, the workflow F corresponding to the project P1 with a project name of “Great Holiday in Las Vegas” is updated from the workflow F1 to the workflow F3.

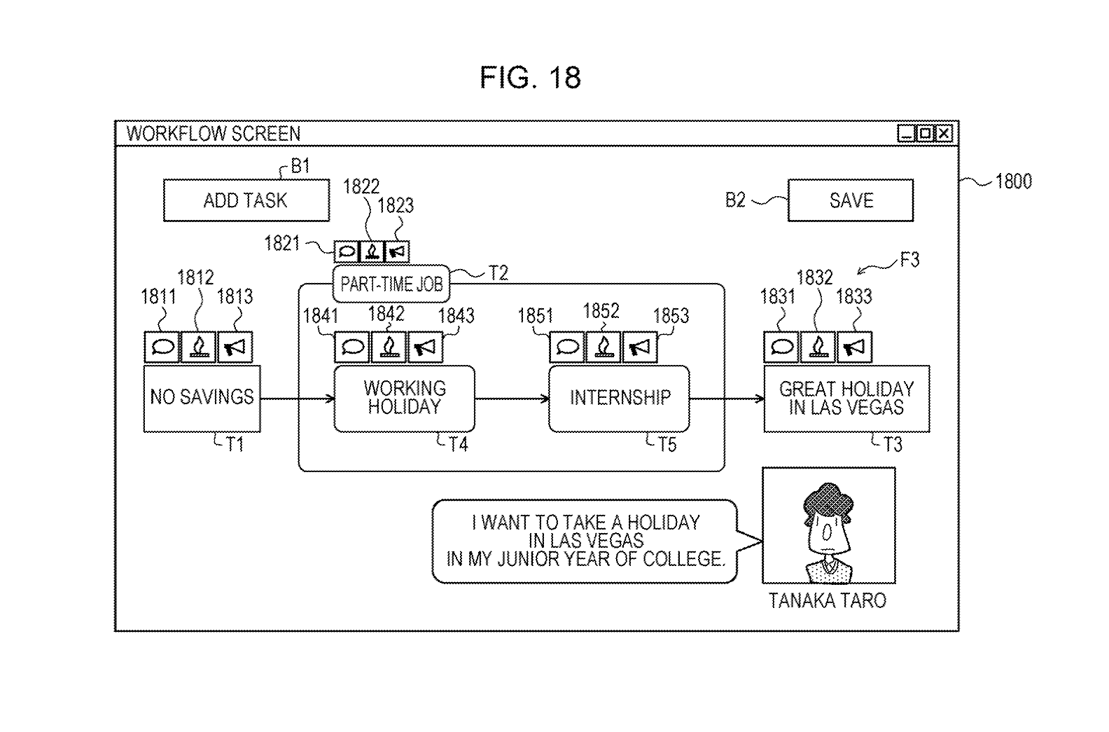

FIG. 18 is an explanatory diagram (No. 2) illustrating another example of the workflow screen. In FIG. 18, a workflow screen 1800 is an operation screen that displays the workflow F3 corresponding to the project P1 with a project name of “Great Holiday in Las Vegas”.

The workflow F3 is a flowchart illustrating a series of steps to achieve an object of “Great Holiday in Las Vegas”. The workflow F3 includes the tasks T1 to T5. At the positions corresponding to the tasks T1 to T5 in the workflow F3, buttons 1811 to 1813, 1821 to 1823, 1831 to 1833, 1841 to 1843, and 1851 to 1853, corresponding to the tasks T1 to T5, are provided, respectively.

When any one of the tasks T in the workflow F3 is selected in the workflow screen 1800, an improvement request that requests an improvement of the selected task T is submitted. Based on the workflow F edited by another (the workflow F3), the user U1 (user name: Tanaka Taro) as the originator of the project P1 is able to request still another user to improve the workflow F3.

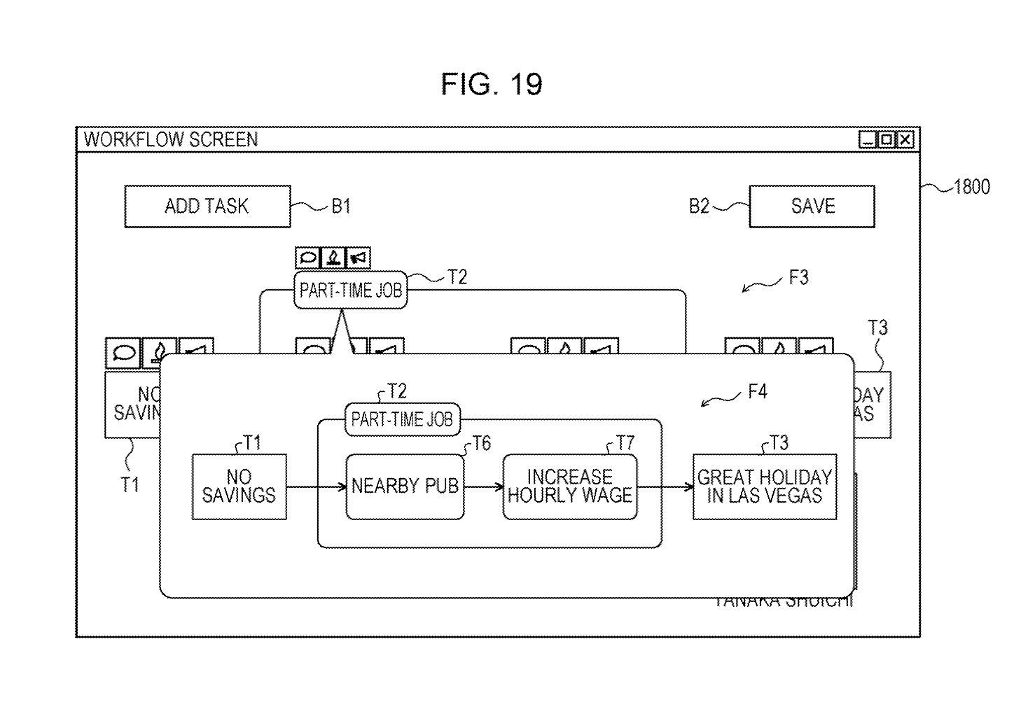

Another workflow F with the task T2 improved may be displayed by a predetermined operation for the task T2 in the workflow F3 on the workflow screen 1800. For example, the workflow F4 illustrated in FIG. 17 may pop up on the workflow screen 1800 as illustrated in FIG. 19 by double clicking the task T2 in the workflow F3.

The information specifying another workflow F (the aforementioned another proposed flow ID, for example) may be set in the project information 500-1 of the project P1. The another workflow F may be specified by the proposed flow ID of the request information 800-1 corresponding to the improvement request that requests an improvement of the task T2 in the unedited workflow F1, for example.

FIG. 19 is an explanatory diagram (No. 3) illustrating a still another example of the workflow screen. In FIG. 19, the workflow screen 1800 displays a pop-up of the another workflow F4 with the task T2 improved. The user U1 (user name: Tanaka Taro) is thereby able to see the another workflow F4 not selected in the workflow selection screen 1700. Furthermore, at execution of the task T2, it is possible to present plural ideas to the executant (the user U1, for example) and provide a wide range of options.

The information processing apparatus 101 may vary the background color of tasks T on the workflow screen depending on the number of improvement requests for each task T. For example, the background is set darker with an increase in number of requests. This makes it possible to determine that tasks T with darker background color are considered more important in the workflow F.

The information processing apparatus 101 may vary the background color of tasks T in the workflow screen depending on the number of responses to improvement requests for each task T. For example, the background is set darker with an increase in number of responses. This makes it possible to determine that tasks T with darker background color have been examined in greater detail.

The information processing apparatus 101 may vary the background color of tasks T in the workflow screen depending on the number of evaluations of each task T. For example, the background is set darker with an increase in number of better stamps. This makes it possible to determine that tasks T with darker background color have richer contents.

(Information Processing Procedure of Information Processing Apparatus 101)

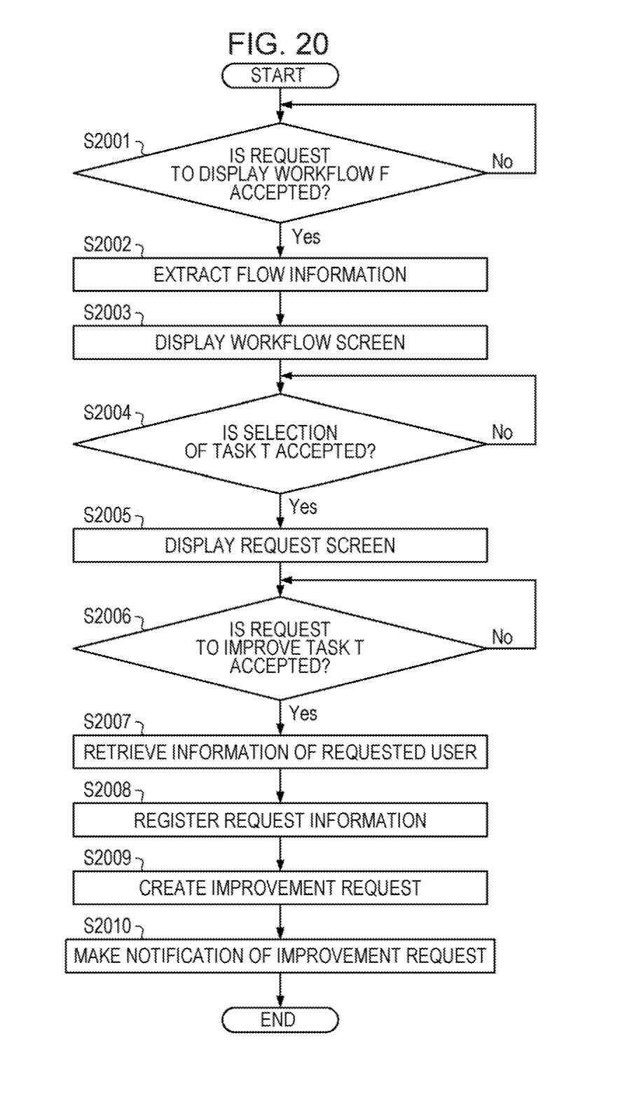

Next, a description is given of various information processing procedures of the information processing apparatus 101 using FIGS. 20 to 22. First, an improvement request processing procedure of the information processing apparatus 101 is described.

FIG. 20 is a flowchart illustrating an example of the improvement request processing procedure of the information processing apparatus 101. In the flowchart of FIG. 20, first, the information processing apparatus 101 determines whether the information processing apparatus 101 has accepted a demand to display the workflow F (step S2001).

Herein, the information processing apparatus 101 waits for the demand to display the workflow F to be accepted (step S2001: No). When the information processing apparatus 101 accepts the demand to display the workflow F (step S2001: Yes), the information processing apparatus 101 extracts flow information of the workflow F specified by the demand to display the workflow F, from the flow DB 230 (step S2002).

Next, based on the extracted flow information, the information processing apparatus 101 displays the workflow screen including the workflow F on the terminal apparatus 201 of the demander (step S2003). The information processing apparatus 101 determines whether the information processing apparatus 101 has accepted selection of a task T in the displayed workflow F (step S2004).

Herein, the information processing apparatus 101 waits for selection of a task T (step S2004: No). When the information processing apparatus 101 accepts selection of a task T (step S2004: Yes), the information processing apparatus 101 displays a request screen which allows selection of a user who is to be requested to improve the selected task T (step S2005).

The information processing apparatus 101 then determines whether the information processing apparatus 101 has accepted an improvement request that requests an improvement of the selected task T (step S2006). Herein, the information processing apparatus 101 waits for the improvement request (step S2006: No). When the information processing apparatus 101 accepts the improvement request (step S2006: Yes), the information processing apparatus 101 retrieves user information of the user requested to improve the selected task T from the user DB 240 (step S2007).

Next, with reference to the retrieved user information, the information processing apparatus 101 registers request information in the request DB 250 (step S2008). With reference to the registered request information, the information processing apparatus 101 then creates information of the improvement request that requests improvement of the selected task T in the workflow F1 (step S2009).

The information processing apparatus 101 notifies the requested user of the created information of the improvement request based on the notification profile of the requested user using the notification service of the requested user (step S2010). The series of steps of the flowchart is thus terminated. The information processing apparatus 101 therefore notifies a user selected by the requesting user of an improvement request that requests an improvement of the selected task T in the workflow F.

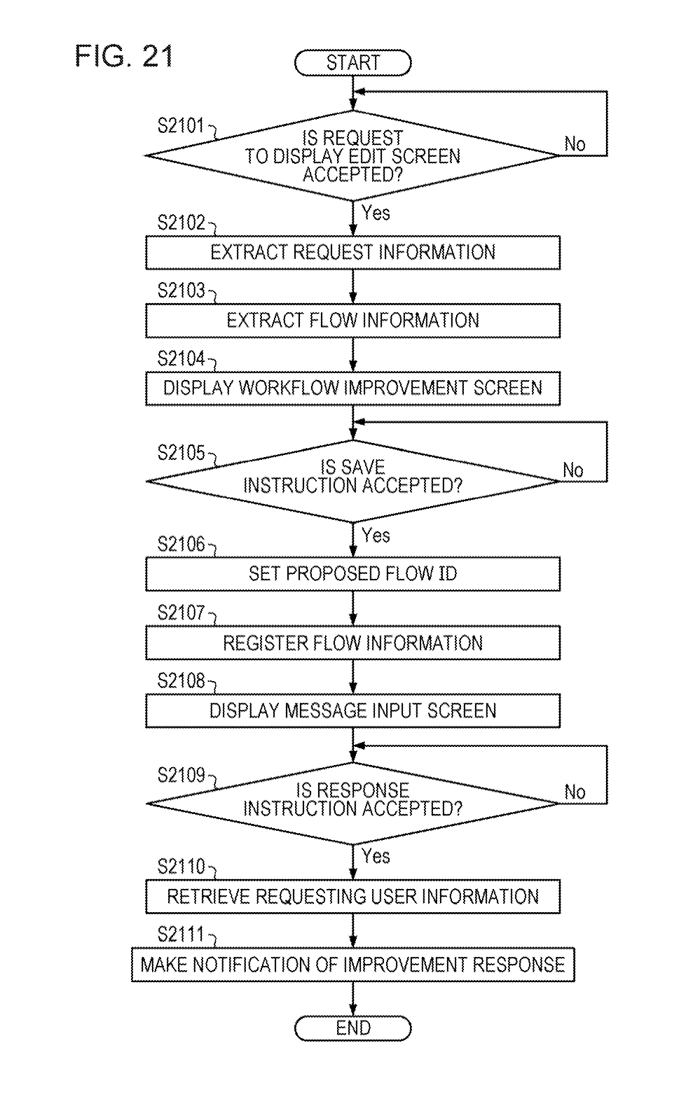

A description is given of an improvement response processing procedure of the information processing apparatus 101 using FIG. 21.

FIG. 21 is a flowchart illustrating an example of the improvement response processing procedure of the information processing apparatus 101. In FIG. 21, the information processing apparatus 101 determines whether the information processing apparatus 101 has accepted a demand to display an edit screen for a workflow F (step S2101).

Herein, the information processing apparatus 101 waits for the demand to display an edit screen to be accepted (step S2101: No). When the information processing apparatus 101 accepts the demand to display the edit screen (Yes: step S2101), the information processing apparatus 101 extracts from the request DB 250, the request information corresponding to the request ID included in the demand to display the edit screen (step S2102).

The information processing apparatus 101 extracts from the flow DB 230, flow information corresponding to the pre-request flow ID of the extracted request information (step S2103). Next, based on the extracted flow information, the information processing apparatus 101 displays the workflow improvement screen on the terminal apparatus 201 of the user who has demanded to display the edit screen (step S2104).

The workflow improvement screen is an operation screen including the workflow F in which the part corresponding to the selected task T in the workflow F is editable and highlighted.

Next, the information processing apparatus 101 determines whether the information processing apparatus 101 has accepted an instruction to store the edited workflow F (step S2105). The information processing apparatus 101 waits for the storing instruction to be accepted (step S2105: No). When the information processing apparatus 101 accepts an instruction to store the edited workflow F (step S2105: Yes), the information processing apparatus 101 numbers the flow ID of the edited workflow F and sets the number in the proposed flow ID of the request information in the request DB 250 corresponding to the request ID included in the storing instruction (step S2106).

Next, based on the flow data included in the storing instruction, the information processing apparatus 101 registers flow information of the edited workflow F in the flow DB 230 (step S2107). The information processing apparatus 101 displays the message input screen (not illustrated), which allows input of a message from the requested user to the requesting user, on the terminal apparatus 201 (step S2108).

Next, the information processing apparatus 101 determines whether the information processing apparatus 101 has accepted an instruction to respond to the improvement request (step S2109). The information processing apparatus 101 waits for the response instruction (step S2109: No). When the information processing apparatus 101 accepts the response instruction (step S2109: Yes), the information processing apparatus 101 retrieves the user information corresponding to the user ID of the requesting user who has submitted the improvement request, from the user DB 240 (step S2110).

With reference to the retrieved user information, the information processing apparatus 101 notifies the requesting user who has submitted the improvement request, based on the notification profile of the requesting user using the notification service of the requesting user (step S2111). The series of steps of the flowchart thus ends. The improvement response refers to information indicating that part corresponding to the selected task T in the workflow F is edited.

In response to acceptance of the instruction to store the edited workflow F, therefore, the information processing apparatus 101 notifies the requesting user who has submitted the improvement request of an improvement response indicating that part corresponding to the selected task T in the workflow F is edited.

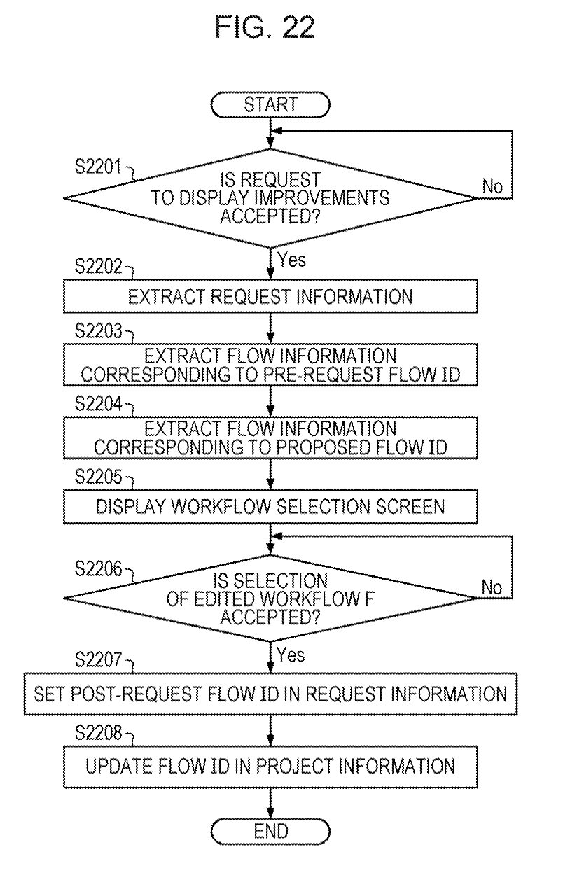

Next, a description is given of the update processing procedure of the information processing apparatus 101 using FIG. 22.

FIG. 22 is a flowchart illustrating an example of the update processing procedure of the information processing apparatus 101. In the flowchart of FIG. 22, the information processing apparatus 101 determines whether the information processing apparatus 101 has accepted a demand to display improvements (step S2201). Herein, the information processing apparatus 101 waits for the demand to display improvements (step S2201: No).

When the information processing apparatus 101 accepts the demand to display improvements (step S2201: Yes), the information processing apparatus 101 extracts from the request DB 250, the request information corresponding to the request ID included in the demand to display improvements (step S2202). The information processing apparatus 101 then extracts from the flow DB 230, flow information corresponding to the pre-request flow ID of the extracted request information (step S2203).

Next, the information processing apparatus 101 extracts from the flow DB 230, flow information corresponding to the proposed flow ID of the extracted request information (step S2204). The information processing apparatus 101 displays the workflow selection screen on the terminal apparatus 201 of the user who has demanded to display improvements, based on the extracted flow information corresponding to the pre-request flow ID and proposed flow ID (step S2205).

The workflow selection screen is an operation screen including unedited and edited workflows F.

Next, the information processing apparatus 101 determines whether the information processing apparatus 101 has accepted selection of an edited workflow F (step S2206). The information processing apparatus 101 waits for selection of an edited workflow F (step S2206: No). When the information processing apparatus 101 accepts selection of an edited workflow F (step S2206: Yes), the information processing apparatus 101 sets the post-request flow ID of the request information corresponding to the request ID of the improvement request to the flow ID of the selected edited workflow F (step S2207).

The information processing apparatus 101 updates the flow ID of the project information in the project DB 220 corresponding to the flow ID of the unedited workflow F to the flow ID of the selected edited workflow F (step S2208). The series of steps of the flowchart thus ends. The unedited workflow F is thereby updated to the edited workflow F selected by the user.

As described above, when any one of tasks T in the displayed workflow F is selected, the information processing apparatus 101 according to the embodiment notifies a predetermined user of an improvement request that requests an improvement of the selected task T. The improvement request that requests the predetermined user to improve a task T is submitted with a simple operation to select the task T in the workflow F.

In accordance with a demand from the requesting user responding to the notification, the information processing apparatus 101 displays the workflow F so that the part corresponding to the selected task T is editable and highlighted. The range of improvement in the workflow F is therefore presented for the predetermined user in an understandable manner.

When any task T in the displayed workflow F is selected, the information processing apparatus 101 displays the input field which allows input of a comment requesting an improvement in the selected task T (the box 1050 illustrated in FIG. 10, for example). The information processing apparatus 101 also notifies the requested user of the improvement request including the comment input in the displayed input field. This allows the requesting user to input a message indicating the details of the improvement request as the comment for the user requested to improve the task T, facilitating explanation of review points and the like.

In response to selection of any task T in the displayed workflow F, the information processing apparatus 101 displays the request screen (the request screen 1000 illustrated in FIG. 10, for example) which allows selection of a user who is to be requested to improve the selected task T. The information processing apparatus 101 therefore notifies the user selected on the displayed request screen of the improvement request. It is thus possible to select a user to be requested to improve the selected task T.

The information processing apparatus 101 displays the request screen including information (the face images 1010, 1020, and 1030 illustrated in FIG. 10, for example) of several users who are selectable as the requested user. For example, the information processing apparatus 101 presents users registered in a contact book of the requesting user and the like as the candidates for the user to be requested to improve the task T.

When acquiring the edited workflow F from the requested user, the information processing apparatus 101 displays the edited workflow F in relation to the requested user for the requesting user who has submitted the improvement request. The workflow F edited by the requested use is therefore presented for the requesting user who has submitted the improvement request.

In response to acquisition of the edited workflow F from the requested user, the information processing apparatus 101 notifies the requesting user of the improvement response indicating that the part corresponding to the selected task T is edited and displays the edited workflow F in accordance with a demand from the requesting user. The workflow F edited by the requested user is presented in accordance with a demand from the requesting user who has submitted the improvement request.

When acquiring the edited workflows F from the respective requested users, the information processing apparatus 101 juxtaposes the edited workflows F acquired from the respective requested users. The workflows F edited by the requested users are juxtaposed for the requesting user who has submitted the improvement request for easy comparison.

In response to selection of any one of the edited workflows F, the information processing apparatus 101 updates the unedited workflow F to the selected edited workflow F. This allows several persons to dynamically create a workflow F to achieve a certain object.

In response to selection of any of the buttons arranged in relation to the tasks T in the displayed workflow F, the information processing apparatus 101 accepts selection of the task T corresponding to the selected button. This facilitates selection of tasks T in the workflow F.

The information processing apparatus 101 displays a workflow F in such a manner that the selected task T and part including the tasks T preceding and/or following the selected task T are editable and highlighted. This allows edit of not only the selected task T in the workflow F but also the tasks T around the selected task T.

With the information processing apparatus 101, it is possible to create a plan in the workflow F to which tasks T may be added or deleted and request acquaintances and experts to improve the workflow F using a task T in the workflow F as a key. This allows process planning to utilize others' abilities. Furthermore, in the process of requesting review, addition, or alteration about a certain point, it is possible to easily explain the review points or the like.

Furthermore, since the sequential relationship between tasks T is displayed in an understandable way, the process to achieve an object is easily understood. This allows users, other than the originator of the project P, to easily join the project P occasionally. Still furthermore, by setting execution period of each task T in the workflow F, for example, it is possible to automatically estimate the time taken to achieve an object.

Still furthermore, the range to be improved is presented clearly for the requested users, so that the requested users respond thereto easily. This allows for specification and management of responsible ranges at sharing creation of the project P (plan). Moreover, only the part corresponding to the selected task T in the workflow F is made editable. It is therefore possible to reduce incorrect entry for the part other than the responsible range of each user. In addition, each task T in the workflow F connects to a certain object. The tasks T may be reused to create a workflow F to achieve a similar object.

The information processing method described in the embodiment is implemented by causing a computer, such as a personal computer or a workstation, to execute previously prepared programs. The information processing program is recorded in a computer-readable recording medium, such as a hard disk, a flexible disk, a CD-ROM, an MO, or a DVD and is loaded from the recoding medium by the computer for execution. The information processing program may be distributed through a network, such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and configured to execute a process including:
displaying a first flowchart illustrating a series of steps to achieve an object, on a terminal of a requesting user;
when one of tasks in the displayed first flowchart is selected, making a notification to a predetermined requested user of an improvement request that requests an improvement of the selected task; and
in accordance with a demand from the predetermined requested user responding to the notification, displaying the first flowchart on a terminal of the predetermined requested user with a part corresponding to the selected task being set editable.

2. The information processing apparatus according to claim 1, wherein
in the making the notification,
in response to the selection of the one of tasks in the displayed first flowchart, an input field is displayed on the terminal of the requesting user, the input field allowing input of a comment that requests an improvement of the selected task, and
the improvement request includes the comment input in the displayed input field.

3. The information processing apparatus according to claim 1, wherein
in the making the notification,
in response to the selection of the one of tasks in the displayed first flowchart, a screen is displayed that allows selection of a user to be requested to improve the selected task as the predetermined requested user, and
a user selected on the displayed screen is notified of the improvement request.

4. The information processing apparatus according to claim 3, wherein
in the making the notification,
the screen includes information of a plurality of users selectable as the predetermined requested user, and
a user selected as the predetermined requested user from the plurality of users is notified of the improvement request.

5. The information processing apparatus according to claim 1, wherein the process further including:
when acquiring an edited flowchart in which the part corresponding to the selected task in the first flowchart is edited from the predetermined requested user, displaying the edited flowchart in relation to the predetermined requested user on the terminal of the requesting user who submitted the improvement request.

6. The information processing apparatus according to claim 5, wherein
in the displaying the edited flowchart,
in response to the acquisition of the edited flowchart from the predetermined requested user, the requesting user is notified of an improvement response indicating that the part corresponding to the selected task is edited, and
in accordance with a demand from the requesting user responding to the notification, the edited flowchart is displayed.

7. The information processing apparatus according to claim 5, wherein the predetermined requested user includes a plurality of requested users, and
when edited flowcharts, in each of which the part corresponding to the selected task in the first flowchart is edited, are acquired from the respective requested users, the edited flowcharts acquired from the respective requested users are displayed as being juxtaposed against each other.

8. The information processing apparatus according to claim 7, wherein
in response to a selection of one of the displayed edited flowcharts, the first flowchart is updated to the selected edited flowchart.

9. The information processing apparatus according to claim 1, wherein in the making the notification,
in response to a selection of one of buttons arranged in relation to the respective tasks in the displayed first flowchart, the selection of the task corresponding to the selected button is accepted.

10. The information processing apparatus according to claim 1, wherein
the part corresponding to the selected task includes the selected task, a task preceding the selected task, and a task following the selected task.

11. An information processing method performed by a computer, the method comprising:
displaying a first flowchart illustrating a series of steps to achieve an object;
when one of tasks in the displayed first flowchart is selected, making a notification to a predetermined requested user of an improvement request that requests an improvement of the selected task; and
in accordance with a demand from the predetermined requested user responding to the notification, displaying the first flowchart on a terminal of the predetermined requested user with a part corresponding to the selected task being set editable.

12. A non-transitory computer-readable storage medium storing an information processing program that causes, when executed, a computer to perform a process comprising:
displaying a first flowchart illustrating a series of steps to achieve an object;
when one of tasks in the displayed first flowchart is selected, making a notification to a predetermined requested user of an improvement request that requests an improvement of the selected task; and
in accordance with a demand from the predetermined requested user responding to the notification, displaying the first flowchart on a terminal of the predetermined requested user with a part corresponding to the selected task being set editable.
